(19) United States
(12) Patent Application Publication
(10) Pub. No.: US 2026/0272010 A1
(43) Pub. Date: Sep. 17, 2026

(54) HEATER ASSEMBLY WITH SHAPED POROUS BODY

(71) Applicant: Philip Morris Products S.A., Neuchatel (CH)

(72) Inventors: Jérôme Christian COURBAT, Cortaillod (CH); Leander DITTMANN, Crissier (CH); Ross Peter JONES, Cambridge (GB)

(73) Assignee: Philip Morris Products S.A., Neuchatel (CH)

(21) Appl. No.: 19/168,124

(22) PCT Filed: Mar. 28, 2024
(86) PCT No.: PCT/EP2024/058659

§ 371 Date: Sep. 23, 2025

(30) Foreign Application Priority Data
Mar. 29, 2023 (EP) 23165114.2

(51) Int. Cl. A24F 40/44; A24F 40/10; A24F 40/42; A24F 40/46; A24F 40/57; H05B 1/02; H05B 3/00; H05B 3/03

(52) U.S. Cl. CPC A24F 40/44; A24F 40/10; A24F 40/42; A24F 40/46; A24F 40/57; H05B 1/0252; H05B 3/0019; H05B 3/03

(57) ABSTRACT

A heater assembly for an aerosol-generating system, the heater assembly including: a heating element configured to vaporise a liquid aerosol-forming substrate; and a porous body configured to convey the liquid aerosol-forming substrate to the heating element, the porous body having a liquid absorption surface and a heating surface, the heating element being located on the heating surface of the porous body, the liquid absorption surface of the porous body having an area that is different from an area of the heating surface of the porous body, the porous body including a shape that tapers from the liquid absorption surface of the porous body towards the heating surface of the porous body, and the porous body further including a porous ceramic body or a porous glass body.

The present disclosure relates to a heater assembly. In particular, but not exclusively, the present disclosure relates to a heater assembly for a handheld electrically operated aerosol-generating system for heating an aerosol-forming substrate to generate an aerosol.

Aerosol-generating systems that heat a liquid aerosol-forming substrate in order to generate an aerosol for delivery to a user are generally known in the prior art. These systems typically comprise an aerosol-generating device and a replaceable cartridge. The cartridge typically includes a liquid aerosol-forming substrate that is capable of releasing volatile compounds when heated. The cartridge typically also includes a heater for heating the liquid aerosol-forming substrate. In known aerosol-generating systems, the heater comprises a resistive heating element wound around a wick that supplies liquid aerosol-forming substrate to the heating element. The aerosol-generating device or cartridge also comprises a mouthpiece. When a user takes a puff on the mouthpiece, an electric current is passed through the heating element causing it to be heated by resistive or Joule heating, which, in turn, heats the liquid aerosol-forming substrate supplied by the wick. This causes volatile compounds to be released from the liquid aerosol-forming substrate that cool to form an aerosol. The aerosol is then drawn into a user's mouth via the mouthpiece.

Such known aerosol-generating systems have a number of drawbacks. For example, they can be difficult to manufacture with consistent manufacturing tolerances which can result in inconsistent vapour production and flavour generation. Inconsistent manufacturing tolerances can also affect the transfer of heat from the heating element to the wick reducing the energy efficiencies of such devices. A further problem encountered by such known aerosol-generating system is “dry heating” or a “dry puff”, which arises when the heating element is heated with insufficient liquid aerosol-forming substrate being supplied to the heating element. This can occur, for example, when a user has consumed all of the liquid aerosol-forming substrate in the cartridge such that the cartridge is depleted of liquid aerosol-forming substrate and needs replacing. During operation, it is preferable to maintain a supply of liquid aerosol-forming substrate to the heating element such that the heating element is maintained in a wet state because this helps to ensure that a satisfactory aerosol is produced when a user takes a puff. Dry heating can result in overheating of the heating element and, potentially, thermal decomposition of the liquid aerosol-forming substrate, which can produce undesirable by-products and an unsatisfactory aerosol. Allowing the aerosol-generating system to continue to operate when liquid aerosol-forming substrate is not being supplied to the heating element can result in a poor user experience.

In an attempt to solve some of the above-mentioned problems, heater assembly designs have been proposed which utilise an atomizer core consisting of a heating element, electrical contacts and a porous atomizer body. Liquid aerosol-forming substrate is supplied from the cartridge's reservoir to the heating element via the pores present within the atomizer body.

It would be desirable to provide a heater assembly that may provide an improved throughput of aerosol.

According to an example of the present disclosure, there is provided a heater assembly for an aerosol-generating system. The heater assembly may comprise a heating element for vaporising a liquid aerosol-forming substrate. The heater assembly may comprise a porous body for conveying the liquid aerosol-forming substrate to the heating element. The porous body may have a liquid absorption surface. The porous body may have a heating surface. The heating element may be located on the heating surface of the porous body. The liquid absorption surface of the porous body may have an area that is different to an area of the heating surface of the porous body. The porous body may comprise a porous ceramic body or a porous glass body.

According to an example of the present disclosure, there is provided a heater assembly for an aerosol-generating system, the heater assembly comprising: a heating element for vaporising a liquid aerosol-forming substrate; and a porous body for conveying the liquid aerosol-forming substrate to the heating element, the porous body having a liquid absorption surface and a heating surface, the heating element being located on the heating surface of the porous body, wherein the liquid absorption surface of the porous body has an area that is different to an area of the heating surface of the porous body, and wherein the porous body comprises a porous ceramic body or a porous glass body.

A heater assembly having a heating surface with the same area as the liquid absorption surface may be inefficient due to heat generated by the heater not being used to vaporise an aerosol-forming substrate. An inefficient heater assembly provides a reduced throughput of aerosol.

Advantageously, providing a porous body in which the heating surface and the liquid absorption surface have different areas may improve the throughput of aerosol that can be generated by the heater assembly compared to a heater assembly in which the heating surface has the same area as the liquid absorption surface.

For example, in a heater assembly in which the area of the heating surface of the porous body is less than the area of the liquid absorption surface of the porous body, heat flow from the heating element towards the liquid absorption surface and then to the liquid storage portion by conduction may be reduced. The relatively smaller heating surface provides a small heat transfer area through which the transfer heat, by conduction, from the heating element to the porous body, and towards the liquid absorption surface.

Decreasing heat loss from the heating element to the bulk of the porous body may consequently increase heating efficiency because more of the heat energy provided by the heating element may be used to vaporise the aerosol-forming substrate. Consequently, the porous body having a shape such that the heating surface has a smaller area than the liquid absorption surface may increase the throughput of aerosol generated by the heater assembly.

For example, in a heater assembly in which the area of the liquid absorption surface of the porous body is less than the area of the heating surface of the porous body, the smaller area of the liquid absorption surface may cause a reduction in heat flow through the aerosol-forming substrate from the heating element to the liquid absorption surface via heat conduction.

Reducing heat flow from the heating surface to the liquid absorption surface may consequently increase heating efficiency because more of the heat energy provided by the heating element may be used to vaporise the liquid aerosol-forming substrate. Consequently, the porous body having a shape such that the liquid absorption surface has a smaller area than the heating surface may provide for increased heating efficiency, which may increase the throughput of aerosol generated by the heater assembly.

Increasing heating efficiency may reduce power consumption during use of the heater assembly.

As used herein, the term “aerosol-generating device” relates to a device that interacts with a liquid aerosol-forming substrate to generate an aerosol.

As used herein, the terms “cartridge” and “aerosol-generating cartridge” relate to a component that interacts with a liquid aerosol-forming device to generate an aerosol. An aerosol-generating cartridge contains, or is configured to contain, a liquid aerosol-forming substrate.

As used herein, the term “liquid aerosol-forming substrate” relates to a liquid substrate capable of releasing volatile compounds that can form an aerosol. Such volatile compounds can be released by heating the aerosol-forming substrate.

As used herein, the term “heating element” refers to a component which transfers heat energy to the liquid aerosol-forming substrate. It will be appreciated that the heating element may be deposited directly on the porous body.

As used herein, the term “porous body” refers to a component which has a plurality of pores, at least some of which are interconnected. The porous body is configured to contain liquid within the plurality of pores.

As used herein, the term “longitudinal axis” is used to describe the axis extending between the liquid absorption surface of the porous body and the heating surface of the porous body.

As used herein, the term “longitudinal” is used to describe the direction between the liquid absorption surface of the porous body and the heating surface of the porous body. During use of the heater assembly, liquid aerosol-forming substrate is drawn from the liquid absorptions surface of the porous body to the heating surface of the porous body substantially along the longitudinal direction.

As used herein, the term “thickness” is used to describe the maximum dimension of the heater assembly, a component of the heater assembly, or a part of the heater assembly in the longitudinal direction. The thickness of the heater assembly, a component of the heater assembly, or a part of the heater assembly may also be referred to as the height of the heater assembly, a component of the heater assembly, or a part of the heater assembly, respectively.

As used herein, the term “an angle between the average vapour emission direction and the average airflow direction” refers to an angle between the directions of travel of the vapour being emitted from the heater assembly and the airflow within the airflow pathway. For example, an angle of zero degrees would mean that the airflow and vapour emissions are travelling in the same direction, whereas an angle of 180 degrees would mean that the directions of travel of the airflow and vapour emission directly oppose one another.

As used herein, the term “thermally insulating” refers to a property in which heat transfer is reduced or restricted. A more thermally insulating component will transfer less heat, via conduction, convection or radiation, than a more thermally insulating component.

The heating element may be located on the porous body.

The heating element may extend across the majority of the heating surface of the porous body. The heating element may extend across substantially all of the heating surface of the porous body.

The heating element may be a fluid permeable heating element. Liquid may pass through a fluid pathway of the porous ceramic body from the liquid absorption surface to the heating surface.

The heating element may comprise a porous layer of electrically conductive material. Advantageously, a heating element comprising a porous layer of electrically conductive material allows an electrical current to flow through the heating element such that the heating element can be resistively heated and also allows vapours to travel through the heating element via the pores in its porous structure. Thus vapour emission occurs through the porous heating element. This avoids the build-up of vapour pressure underneath the heating element and high speed vapour emission at the sides of the heating element. The inventors have found that this arrangement produces a consistent vapour across the heating element and a lower vapour emission speed of approximately 0.1 metres per second. Such a low vapour emission speed means that the vapour is easily carried away by the airflow reducing the impingement of vapour on the internal walls of the aerosol-generating system.

The heating element may be coupled to the heating surface of the porous body.

The heating element may be electrically connected to electrical contacts. The heating element may be configured to heat the liquid aerosol-forming substrate upon application of an electrical potential difference to the electrical contacts. The heating element may be one or more of a curvilinear or a serpentine shape. The heating element may comprise an electrically resistive heating element. The heating element may be made from any suitable electrically conductive material. Suitable materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, constantan, nickel-, cobalt-, chromium-, aluminum-, titanium-, zirconium-, hafnium-, niobium-, molybdenum-, tantalum-, tungsten-, tin-, gallium-, manganese- and iron-containing alloys, and super-alloys based on nickel, iron, cobalt, stainless steel, Timetal®, iron-aluminum based alloys and iron-manganese-aluminum based alloys. Timetal® is a registered trade mark of Titanium Metals Corporation. The heating element may be made from stainless steel, for example, a 300 series stainless steel such as AISI 304, 316, 304L, 316L. The electrical heating element may comprise one of more of NiCr and TiZr.

Additionally, the heating element may comprise combinations of the above materials. A combination of materials may be used to improve the control of the resistance of the heating element. For example, materials with a high intrinsic resistance may be combined with materials with a low intrinsic resistance. This may be advantageous if one of the materials is more beneficial from other perspectives, for example price, machinability or other physical and chemical parameters. Advantageously, high resistivity heating allow more efficient use of battery energy.

The heating element and the porous body may be integrally formed.

The heating element and the porous body may be moulded as a single monolithic piece.

Advantageously, this may help to simplify the manufacturing of the heater assembly by reducing manufacturing times and providing a more cost effective solution. This may advantageously create a tight mechanical connection between the heating element and the porous body.

The heating element maybe a doped portion of the porous body.

The porous body may be doped such that the portion of the porous body which acts as the heating element is electrically conductive. Doping the porous body may be advantageous in that it avoids altering the porosity of the porous body. This may be preferable to other known techniques of forming a heating element, which involve depositing the heating element by thin film or thick film techniques, which can reduce the properties of the porous body, in particular the porosity. The doped portion may be between 5 micrometres and 100 micrometres in thickness. The thickness of the doped portion may be increased where the cross sectional area of the heating element is smaller or where the heating resistance required is higher. The dopant used to dope the porous body may be an n-type dopant or a p-type dopant. The dopant may be any one of, but not limited to, nitrogen, phosphorous, aluminium or boron. The interface between the heating element and the porous body may comprise a portion of partially doped porous material.

The heating element may be located on and bonded to the heating surface of the porous body.

The porous body may be substantially incompressible. The porous body may be incompressible.

The porous body may have a porosity of between 30% and 70%. The porous body may be an open-cell porous body.

The porous body may have been manufactured by sintering. The porous body may have been manufactured by directly sintering a ceramic powder, to form a porous body having pores between interconnected powder particles. The porous body may have been manufactured by using a sacrificial material within a ceramic powder, the sacrificial material being used as a spacer to form pores. The sacrificial material may have been burnt off during sintering.

The porous body may have a trapezoid prism shape. The porous body may have a pyramid shape. The porous body may have a truncated pyramid shape. The porous body may have a cone shape. The porous body may have a truncated cone shape. The shape of the porous body may conform to a chamber in a cartridge. The shape of the porous body may conform to the shape of the heating element.

The porous body may have a first average pore size at the liquid absorption surface, and a second average pore size at the heating surface. The first average pore size may be substantially the same as the second average pore size.

The porous body may be a porous ceramic body. The porous body may be a porous glass body.

The liquid absorption surface may oppose the heating surface.

The liquid absorption surface and the heating surface may be substantially parallel to one another.

The liquid absorption surface of the porous body may be substantially flat.

The heating surface of the porous body may be substantially flat. The heating surface may be a porous outer surface of the porous body. The heating element may at least partially extend into pores of the porous body that are adjacent the heating surface.

The heating surface of the porous body on which the heating element is located may have an area that is substantially the same as the heating element.

The heating surface may have a size that is less than or equal to the size of the heating element. The heating surface may have a size that is less than the size of the heating element.

The heating surface may have an area that is less than or equal to the area of the heating element. The heating surface may have an area that is less than the area of the heating element.

The area of the heating surface of the porous body may be less than the area of the liquid absorption surface of the porous body. The area of the liquid absorption surface of the porous body may be greater than the area of the heating surface of the porous body.

Advantageously, when the porous body has a shape such that the heating surface has a smaller area than the liquid absorption surface, heat flow from the heating element towards the liquid absorption surface and then to the liquid storage portion by conduction may be reduced. The relatively smaller heating surface provides a small heat transfer area through which the transfer heat, by conduction, from the heating element to the porous body, and towards the liquid absorption surface.

Decreasing heat loss from the heating element to the bulk of the porous body may consequently increase heating efficiency because more of the heat energy provided by the heating element may be used to vaporise the aerosol-forming substrate. Consequently, the porous body having a shape such that the heating surface has a smaller area than the liquid absorption surface may increase the throughput of aerosol generated by the heater assembly.

Advantageously, the porous body having a shape such that the heating surface has a smaller area than the liquid absorption surface may reduce the area of the heating surface that is not close enough to the heating element to allow aerosol-forming substrate being conveyed to the heating surface to be vaporised. In other words, the size and shape of the heating surface may more closely match with the size and shape of the heating element. Consequently, more of the liquid aerosol-forming substrate may be conveyed from the liquid absorption surface to an area of the heating surface that is near to the heating element, which may result in more of the liquid aerosol-forming substrate at the heating surface being vaporised. More liquid aerosol-forming substrate being vaporised may increase the throughput of aerosol generated by the heater assembly. Further, this arrangement may allow for the power density at the heating surface to be maximised, which also improves heating efficiency.

Advantageously, the liquid absorption surface having a larger area than the heating surface may allow the liquid absorption surface to receive a larger volume of liquid aerosol-substrate from a liquid storage portion. As a consequence of the relatively smaller area of the heating surface, as the liquid aerosol-forming substrate is conveyed through the porous body and towards the heating surface, the flow rate of the liquid aerosol-forming substrate to the heating element may be higher than with a typical heater assembly. A higher flow rate of liquid aerosol-forming substrate at the heating element may increase the throughput of aerosol generated by the heater assembly.

The heating surface may have an area of at least 0.5 square millimetres. The heating surface may have an area of at least 1 square millimetre. The heating surface may have an area of at least 2 square millimetres. The heating surface may have an area of at least 3 square millimetres. The heating surface may have an area of at least 5 square millimetres. The heating surface may have an area of at least 10 square millimetres. The heating surface may have an area of at least 15 square millimetres. The heating surface may have an area of at least 20 square millimetres. The heating surface may have an area of at least 25 square millimetres.

The heating surface may have an area of less than or equal to 40 square millimetres. The heating surface may have an area of less than or equal to 30 square millimetres. The heating surface may have an area of less than or equal to 25 square millimetres. The heating surface may have an area of less than or equal to 20 square millimetres. The heating surface may have an area of less than or equal to 15 square millimetres. The heating surface may have an area of less than or equal to 10 square millimetres. The heating surface may have an area of less than or equal to 5 square millimetres.

The heating surface may have an area of between 0.5 square millimetres and 40 square millimetres. The heating surface may have an area of between 0.5 square millimetres and 30 square millimetres. The heating surface may have an area of between 1 square millimetre and 30 square millimetres. The heating surface may have an area of between 2 square millimetres and 25 square millimetres. The heating surface may have an area of between 3 square millimetres and 20 square millimetres. The heating surface may have an area of between 5 square millimetres and 15 square millimetres.

The liquid absorption surface may have an area of at least 1 square millimetre. The liquid absorption surface may have an area of at least 2 square millimetres. The liquid absorption surface may have an area of at least 3 square millimetres. The liquid absorption surface may have an area of at least 5 square millimetres. The liquid absorption surface may have an area of at least 10 square millimetres. The liquid absorption surface may have an area of at least 20 square millimetres. The liquid absorption surface may have an area of at least 30 square millimetres. The liquid absorption surface may have an area of at least 40 square millimetres. The liquid absorption surface may have an area of at least 50 square millimetres. The liquid absorption surface may have an area of at least 60 square millimetres. The liquid absorption surface may have an area of at least 70 square millimetres. The liquid absorption surface may have an area of at least 80 square millimetres. The liquid absorption surface may have an area of at least 90 square millimetres.

The liquid absorption surface may have an area of less than or equal to 100 square millimetres. The liquid absorption surface may have an area of less than or equal to 90 square millimetres. The liquid absorption surface may have an area of less than or equal to 80 square millimetres. The liquid absorption surface may have an area of less than or equal to 70 square millimetres. The liquid absorption surface may have an area of less than or equal to 60 square millimetres. The liquid absorption surface may have an area of less than or equal to 50 square millimetres. The liquid absorption surface may have an area of less than or equal to 40 square millimetres. The liquid absorption surface may have an area of less than or equal to 30 square millimetres. The liquid absorption surface may have an area of less than or equal to 20 square millimetres. The liquid absorption surface may have an area of less than or equal to 10 square millimetres.

The liquid absorption surface may have an area of between 1 square millimetre and 100 square millimetres. The liquid absorption surface may have an area of between 2 square millimetres and 100 square millimetres. The liquid absorption surface may have an area of between 2 square millimetres and 90 square millimetres. The liquid absorption surface may have an area of between 3 square millimetres and 80 square millimetres. The liquid absorption surface may have an area of between 5 square millimetres and 70 square millimetres. The liquid absorption surface may have an area of between 10 square millimetres and 60 square millimetres. The liquid absorption surface may have an area of between 20 square millimetres and 50 square millimetres. The liquid absorption surface may have an area of between 30 square millimetres and 40 square millimetres.

A ratio of the area of the heating surface of the porous body to the area of the liquid absorption surface of the porous body may be less than or equal to 0.9. A ratio of the area of the heating surface of the porous body to the area of the liquid absorption surface of the porous body may be less than or equal to 0.8. A ratio of the area of the heating surface of the porous body to the area of the liquid absorption surface of the porous body may be less than or equal to 0.7. A ratio of the area of the heating surface of the porous body to the area of the liquid absorption surface of the porous body may be less than or equal to 0.6. A ratio of the area of the heating surface of the porous body to the area of the liquid absorption surface of the porous body may be less than or equal to 0.5. A ratio of the area of the heating surface of the porous body to the area of the liquid absorption surface of the porous body may be less than or equal to 0.4. A ratio of the area of the heating surface of the porous body to the area of the liquid absorption surface of the porous body may be less than or equal to 0.3. A ratio of the area of the heating surface of the porous body to the area of the liquid absorption surface of the porous body may be less than or equal to 0.2.

A ratio of the area of the heating surface of the porous body to the area of the liquid absorption surface of the porous body may be at least 0.1. A ratio of the area of the heating surface of the porous body to the area of the liquid absorption surface of the porous body may be at least 0.2. A ratio of the area of the heating surface of the porous body to the area of the liquid absorption surface of the porous body may be at least 0.3. A ratio of the area of the heating surface of the porous body to the area of the liquid absorption surface of the porous body may be at least 0.4. A ratio of the area of the heating surface of the porous body to the area of the liquid absorption surface of the porous body may be at least 0.5. A ratio of the area of the heating surface of the porous body to the area of the liquid absorption surface of the porous body may be at least 0.6. A ratio of the area of the heating surface of the porous body to the area of the liquid absorption surface of the porous body may be at least 0.7. A ratio of the area of the heating surface of the porous body to the area of the liquid absorption surface of the porous body may be at least 0.8.

A ratio of the area of the heating surface of the porous body to the area of the liquid absorption surface of the porous body may be between 0.1 and 0.9. A ratio of the area of the heating surface of the porous body to the area of the liquid absorption surface of the porous body may be between 0.2 and 0.8. A ratio of the area of the heating surface of the porous body to the area of the liquid absorption surface of the porous body may be between 0.3 and 0.7. A ratio of the area of the heating surface of the porous body to the area of the liquid absorption surface of the porous body may be between 0.4 and 0.6.

The heating surface of the porous body may have a width that is different to a width of the liquid absorption surface of the porous body. The heating surface of the porous body may have a width that is different to a width of the liquid absorption surface of the porous body in a same transverse direction.

The heating surface of the porous body may have a width that is less than the width of the liquid absorption surface of the porous body. The liquid absorption surface of the porous body may have a width that is greater than the width of the heating surface of the porous body.

A ratio of the width of the heating surface of the porous body to the width of the liquid absorption surface of the porous body may be less than or equal to 0.9. A ratio of the width of the heating surface of the porous body to the width of the liquid absorption surface of the porous body may be less than or equal to 0.8. A ratio of the width of the heating surface of the porous body to the width of the liquid absorption surface of the porous body may be less than or equal to 0.7. A ratio of the width of the heating surface of the porous body to the width of the liquid absorption surface of the porous body may be less than or equal to 0.6. A ratio of the width of the heating surface of the porous body to the width of the liquid absorption surface of the porous body may be less than or equal to 0.5. A ratio of the width of the heating surface of the porous body to the width of the liquid absorption surface of the porous body may be less than or equal to 0.4. A ratio of the width of the heating surface of the porous body to the width of the liquid absorption surface of the porous body may be less than or equal to 0.3. A ratio of the width of the heating surface of the porous body to the width of the liquid absorption surface of the porous body may be less than or equal to 0.2.

A ratio of the width of the heating surface of the porous body to the width of the liquid absorption surface of the porous body may be at least 0.1. A ratio of the width of the heating surface of the porous body to the width of the liquid absorption surface of the porous body may be at least 0.2. A ratio of the width of the heating surface of the porous body to the width of the liquid absorption surface of the porous body may be at least 0.3. A ratio of the width of the heating surface of the porous body to the width of the liquid absorption surface of the porous body may be at least 0.4. A ratio of the width of the heating surface of the porous body to the width of the liquid absorption surface of the porous body may be at least 0.5. A ratio of the width of the heating surface of the porous body to the width of the liquid absorption surface of the porous body may be at least 0.6. A ratio of the width of the heating surface of the porous body to the width of the liquid absorption surface of the porous body may be at least 0.7. A ratio of the width of the heating surface of the porous body to the width of the liquid absorption surface of the porous body may be at least 0.8.

A ratio of the width of the heating surface of the porous body to the width of the liquid absorption surface of the porous body may be between 0.1 and 0.9. A ratio of the width of the heating surface of the porous body to the width of the liquid absorption surface of the porous body may be between 0.2 and 0.8. A ratio of the width of the heating surface of the porous body to the width of the liquid absorption surface of the porous body may be between 0.3 and 0.7. A ratio of the width of the heating surface of the porous body to the width of the liquid absorption surface of the porous body may be between 0.4 and 0.6.

The heating surface of the porous body may have a length that is less than the length of the liquid absorption surface of the porous body. The liquid absorption surface of the porous body may have a length that is greater than the length of the heating surface of the porous body.

A ratio of the length of the heating surface of the porous body to the length of the liquid absorption surface of the porous body may be less than or equal to 0.9. A ratio of the length of the heating surface of the porous body to the length of the liquid absorption surface of the porous body may be less than or equal to 0.8. A ratio of the length of the heating surface of the porous body to the length of the liquid absorption surface of the porous body may be less than or equal to 0.7. A ratio of the length of the heating surface of the porous body to the length of the liquid absorption surface of the porous body may be less than or equal to 0.6. A ratio of the length of the heating surface of the porous body to the length of the liquid absorption surface of the porous body may be less than or equal to 0.5. A ratio of the length of the heating surface of the porous body to the length of the liquid absorption surface of the porous body may be less than or equal to 0.4. A ratio of the length of the heating surface of the porous body to the length of the liquid absorption surface of the porous body may be less than or equal to 0.3. A ratio of the length of the heating surface of the porous body to the length of the liquid absorption surface of the porous body may be less than or equal to 0.2.

A ratio of the length of the heating surface of the porous body to the length of the liquid absorption surface of the porous body may be at least 0.1. A ratio of the length of the heating surface of the porous body to the length of the liquid absorption surface of the porous body may be at least 0.2. A ratio of the length of the heating surface of the porous body to the length of the liquid absorption surface of the porous body may be at least 0.3. A ratio of the length of the heating surface of the porous body to the length of the liquid absorption surface of the porous body may be at least 0.4. A ratio of the length of the heating surface of the porous body to the length of the liquid absorption surface of the porous body may be at least 0.5. A ratio of the length of the heating surface of the porous body to the length of the liquid absorption surface of the porous body may be at least 0.6. A ratio of the length of the heating surface of the porous body to the length of the liquid absorption surface of the porous body may be at least 0.7. A ratio of the length of the heating surface of the porous body to the length of the liquid absorption surface of the porous body may be at least 0.8.

A ratio of the length of the heating surface of the porous body to the length of the liquid absorption surface of the porous body may be between 0.1 and 0.9. A ratio of the length of the heating surface of the porous body to the length of the liquid absorption surface of the porous body may be between 0.2 and 0.8. A ratio of the length of the heating surface of the porous body to the length of the liquid absorption surface of the porous body may be between 0.3 and 0.7. A ratio of the length of the heating surface of the porous body to the length of the liquid absorption surface of the porous body may be between 0.4 and 0.6.

The heating surface of the porous body may have a width or a length that is less than a width of the liquid absorption surface of the porous body.

The heating surface of the porous body may have a perimeter that is less than the perimeter of the liquid absorption surface of the porous body. The liquid absorption surface of the porous body may have a perimeter that is greater than the perimeter of the heating surface of the porous body.

The heating surface of the porous body may have a diameter that is less than the diameter of the liquid absorption surface of the porous body. The liquid absorption surface of the porous body may have a diameter that is greater than the diameter of the heating surface of the porous body.

A ratio of the diameter of the heating surface of the porous body to the diameter of the liquid absorption surface of the porous body may be less than or equal to 0.9. A ratio of the diameter of the heating surface of the porous body to the diameter of the liquid absorption surface of the porous body may be less than or equal to 0.8. A ratio of the diameter of the heating surface of the porous body to the diameter of the liquid absorption surface of the porous body may be less than or equal to 0.7. A ratio of the diameter of the heating surface of the porous body to the diameter of the liquid absorption surface of the porous body may be less than or equal to 0.6. A ratio of the diameter of the heating surface of the porous body to the diameter of the liquid absorption surface of the porous body may be less than or equal to 0.5. A ratio of the diameter of the heating surface of the porous body to the diameter of the liquid absorption surface of the porous body may be less than or equal to 0.4. A ratio of the diameter of the heating surface of the porous body to the diameter of the liquid absorption surface of the porous body may be less than or equal to 0.3. A ratio of the diameter of the heating surface of the porous body to the diameter of the liquid absorption surface of the porous body may be less than or equal to 0.2.

A ratio of the diameter of the heating surface of the porous body to the diameter of the liquid absorption surface of the porous body may be at least 0.1. A ratio of the diameter of the heating surface of the porous body to the diameter of the liquid absorption surface of the porous body may be at least 0.2. A ratio of the diameter of the heating surface of the porous body to the diameter of the liquid absorption surface of the porous body may be at least 0.3. A ratio of the diameter of the heating surface of the porous body to the diameter of the liquid absorption surface of the porous body may be at least 0.4. A ratio of the diameter of the heating surface of the porous body to the diameter of the liquid absorption surface of the porous body may be at least 0.5. A ratio of the diameter of the heating surface of the porous body to the diameter of the liquid absorption surface of the porous body may be at least 0.6. A ratio of the diameter of the heating surface of the porous body to the diameter of the liquid absorption surface of the porous body may be at least 0.7. A ratio of the diameter of the heating surface of the porous body to the diameter of the liquid absorption surface of the porous body may be at least 0.8.

A ratio of the diameter of the heating surface of the porous body to the diameter of the liquid absorption surface of the porous body may be between 0.1 and 0.9. A ratio of the diameter of the heating surface of the porous body to the diameter of the liquid absorption surface of the porous body may be between 0.2 and 0.8. A ratio of the diameter of the heating surface of the porous body to the diameter of the liquid absorption surface of the porous body may be between 0.3 and 0.7. A ratio of the diameter of the heating surface of the porous body to the diameter of the liquid absorption surface of the porous body may be between 0.4 and 0.6.

The heating surface of the porous body may have a circumference that is less than the circumference of the liquid absorption surface of the porous body. The liquid absorption surface of the porous body may have a circumference that is greater than the circumference of the heating surface of the porous body.

The porous body may comprise a shape that tapers from the liquid absorption surface of the porous body towards the heating surface of the porous body. The porous body may comprise a shape that tapers from the liquid absorption surface of the porous body to the heating surface of the porous body.

The area of the heating surface of the porous body may be greater than the area of the liquid absorption surface of the porous body. The area of the liquid absorption surface of the porous body may be less than the area of the heating surface of the porous body.

Advantageously, when the porous body has a shape such that the liquid absorption surface has a smaller area than the heating surface, the smaller area of the liquid absorption surface may cause a reduction in heat flow through the aerosol-forming substrate from the heating element to the liquid absorption surface via heat conduction. Reducing heat flow from the heating surface to the liquid absorption surface may consequently increase thermal efficiency because more of the heat energy provided by the heating element may be used to vaporise the liquid aerosol-forming substrate. Consequently, the porous body having a shape such that the liquid absorption surface has a smaller area than the heating surface may provide for increased heating efficiency, which may increase the throughput of aerosol generated by the heater assembly.

Advantageously, the porous body having a shape such that the liquid absorption surface has a smaller area than the heating surface may reduce the area of the heating surface that is not close enough to the heating element to allow aerosol-forming substrate being conveyed to the heating surface to be vaporised. In other words, the size and shape of the heating surface may more closely match with the size and shape of the heating element. Consequently, more of the liquid aerosol-forming substrate being may be conveyed from the liquid absorption surface and to an area of the heating surface that is near to the heating element, which may result in more of the liquid aerosol-forming substrate at the heating surface being vaporised. More liquid aerosol-forming substrate being vaporised may increase the throughput of aerosol generated by the heater assembly.

The heating surface may have an area of at least 1 square millimetre. The heating surface may have an area of at least 2 square millimetres. The heating surface may have an area of at least 3 square millimetres. The heating surface may have an area of at least 5 square millimetres. The heating surface may have an area of at least 10 square millimetres. The heating surface may have an area of at least 20 square millimetres. The heating surface may have an area of at least 30 square millimetres. The heating surface may have an area of at least 40 square millimetres. The heating surface may have an area of at least 50 square millimetres. The heating surface may have an area of at least 60 square millimetres. The heating surface may have an area of at least 70 square millimetres. The heating surface may have an area of at least 80 square millimetres. The heating surface may have an area of at least 90 square millimetres.

The heating surface may have an area of less than or equal to 100 square millimetres. The heating surface may have an area of less than or equal to 90 square millimetres. The heating surface may have an area of less than or equal to 80 square millimetres. The heating surface may have an area of less than or equal to 70 square millimetres. The heating surface may have an area of less than or equal to 60 square millimetres. The heating surface may have an area of less than or equal to 50 square millimetres. The heating surface may have an area of less than or equal to 40 square millimetres. The heating surface may have an area of less than or equal to 30 square millimetres. The heating surface may have an area of less than or equal to 20 square millimetres. The heating surface may have an area of less than or equal to 10 square millimetres.

The heating surface may have an area of between 1 square millimetre and 100 square millimetres. The heating surface may have an area of between 2 square millimetres and 100 square millimetres. The heating surface may have an area of between 2 square millimetres and 90 square millimetres. The heating surface may have an area of between 3 square millimetres and 80 square millimetres. The heating surface may have an area of between 5 square millimetres and 70 square millimetres. The heating surface may have an area of between 10 square millimetres and 60 square millimetres. The heating surface may have an area of between 20 square millimetres and 50 square millimetres. The heating surface may have an area of between 30 square millimetres and 40 square millimetres.

The liquid absorption surface may have an area of at least 0.5 square millimetres. The liquid absorption surface may have an area of at least 1 square millimetre. The liquid absorption surface may have an area of at least 2 square millimetres. The liquid absorption surface may have an area of at least 3 square millimetres. The liquid absorption surface may have an area of at least 5 square millimetres. The liquid absorption surface may have an area of at least 10 square millimetres. The liquid absorption surface may have an area of at least 15 square millimetres. The liquid absorption surface may have an area of at least 20 square millimetres. The liquid absorption surface may have an area of at least 25 square millimetres.

The liquid absorption surface may have an area of less than or equal to 40 square millimetres. The liquid absorption surface may have an area of less than or equal to 30 square millimetres. The liquid absorption surface may have an area of less than or equal to 25 square millimetres. The liquid absorption surface may have an area of less than or equal to 20 square millimetres. The liquid absorption surface may have an area of less than or equal to 15 square millimetres. The liquid absorption surface may have an area of less than or equal to 10 square millimetres. The liquid absorption surface may have an area of less than or equal to 5 square millimetres.

The liquid absorption surface may have an area of between 0.5 square millimetres and 40 square millimetres. The liquid absorption surface may have an area of between 0.5 square millimetres and 30 square millimetres. The liquid absorption surface may have an area of between 1 square millimetre and 30 square millimetres. The liquid absorption surface may have an area of between 2 square millimetres and 25 square millimetres. The liquid absorption surface may have an area of between 3 square millimetres and 20 square millimetres. The liquid absorption surface may have an area of between 5 square millimetres and 15 square millimetres.

A ratio of the area of the liquid absorption surface of the porous body to the area of the heating surface of the porous body may be less than or equal to 0.9. A ratio of the area of the liquid absorption surface of the porous body to the area of the heating surface of the porous body may be less than or equal to 0.8. A ratio of the area of the liquid absorption surface of the porous body to the area of the heating surface of the porous body may be less than or equal to 0.7. A ratio of the area of the liquid absorption surface of the porous body to the area of the heating surface of the porous body may be less than or equal to 0.6. A ratio of the area of the liquid absorption surface of the porous body to the area of the heating surface of the porous body may be less than or equal to 0.5. A ratio of the area of the liquid absorption surface of the porous body to the area of the heating surface of the porous body may be less than or equal to 0.4. A ratio of the area of the liquid absorption surface of the porous body to the area of the heating surface of the porous body may be less than or equal to 0.3. A ratio of the area of the liquid absorption surface of the porous body to the area of the heating surface of the porous body may be less than or equal to 0.2.

A ratio of the area of the liquid absorption surface of the porous body to the area of the heating surface of the porous body may be at least 0.1. A ratio of the area of the liquid absorption surface of the porous body to the area of the heating surface of the porous body may be at least 0.2. A ratio of the area of the liquid absorption surface of the porous body to the area of the heating surface of the porous body may be at least 0.3. A ratio of the area of the liquid absorption surface of the porous body to the area of the heating surface of the porous body may be at least 0.4. A ratio of the area of the liquid absorption surface of the porous body to the area of the heating surface of the porous body may be at least 0.5. A ratio of the area of the liquid absorption surface of the porous body to the area of the heating surface of the porous body may be at least 0.6. A ratio of the area of the liquid absorption surface of the porous body to the area of the heating surface of the porous body may be at least 0.7. A ratio of the area of the liquid absorption surface of the porous body to the area of the heating surface of the porous body may be at least 0.8.

A ratio of the area of the liquid absorption surface of the porous body to the area of the heating surface of the porous body may be between 0.1 and 0.9. A ratio of the area of the liquid absorption surface of the porous body to the area of the heating surface of the porous body may be between 0.2 and 0.8. A ratio of the area of the liquid absorption surface of the porous body to the area of the heating surface of the porous body may be between 0.3 and 0.7. A ratio of the area of the liquid absorption surface of the porous body to the area of the heating surface of the porous body may be between 0.4 and 0.6.

The heating surface of the porous body may have a width that is greater than the width of the liquid absorption surface of the porous body. The liquid absorption surface of the porous body may have a width that is less than the width of the heating surface of the porous body.

A ratio of the width of the liquid absorption surface of the porous body to the width of the heating surface of the porous body may be less than or equal to 0.9. A ratio of the width of the liquid absorption surface of the porous body to the width of the heating surface of the porous body may be less than or equal to 0.8. A ratio of the width of the liquid absorption surface of the porous body to the width of the heating surface of the porous body may be less than or equal to 0.7. A ratio of the width of the liquid absorption surface of the porous body to the width of the heating surface of the porous body may be less than or equal to 0.6. A ratio of the width of the liquid absorption surface of the porous body to the width of the heating surface of the porous body may be less than or equal to 0.5. A ratio of the width of the liquid absorption surface of the porous body to the width of the heating surface of the porous body may be less than or equal to 0.4. A ratio of the width of the liquid absorption surface of the porous body to the width of the heating surface of the porous body may be less than or equal to 0.3. A ratio of the width of the liquid absorption surface of the porous body to the width of the heating surface of the porous body may be less than or equal to 0.2.

A ratio of the width of the liquid absorption surface of the porous body to the width of the heating surface of the porous body may be at least 0.1. A ratio of the width of the liquid absorption surface of the porous body to the width of the heating surface of the porous body may be at least 0.2. A ratio of the width of the liquid absorption surface of the porous body to the width of the heating surface of the porous body may be at least 0.3. A ratio of the width of the liquid absorption surface of the porous body to the width of the heating surface of the porous body may be at least 0.4. A ratio of the width of the liquid absorption surface of the porous body to the width of the heating surface of the porous body may be at least 0.5. A ratio of the width of the liquid absorption surface of the porous body to the width of the heating surface of the porous body may be at least 0.6. A ratio of the width of the liquid absorption surface of the porous body to the width of the heating surface of the porous body may be at least 0.7. A ratio of the width of the liquid absorption surface of the porous body to the width of the heating surface of the porous body may be at least 0.8.

A ratio of the width of the liquid absorption surface of the porous body to the width of the heating surface of the porous body may be between 0.1 and 0.9. A ratio of the width of the liquid absorption surface of the porous body to the width of the heating surface of the porous body may be between 0.2 and 0.8. A ratio of the width of the liquid absorption surface of the porous body to the width of the heating surface of the porous body may be between 0.3 and 0.7. A ratio of the width of the liquid absorption surface of the porous body to the width of the heating surface of the porous body may be between 0.4 and 0.6.

The heating surface of the porous body may have a length that is greater than the length of the liquid absorption surface of the porous body. The liquid absorption surface of the porous body may have a length that is less than the length of the heating surface of the porous body.

A ratio of the length of the liquid absorption surface of the porous body to the length of the heating surface of the porous body may be less than or equal to 0.9. A ratio of the length of the liquid absorption surface of the porous body to the length of the heating surface of the porous body may be less than or equal to 0.8. A ratio of the length of the liquid absorption surface of the porous body to the length of the heating surface of the porous body may be less than or equal to 0.7. A ratio of the length of the liquid absorption surface of the porous body to the length of the heating surface of the porous body may be less than or equal to 0.6. A ratio of the length of the liquid absorption surface of the porous body to the length of the heating surface of the porous body may be less than or equal to 0.5. A ratio of the length of the liquid absorption surface of the porous body to the length of the heating surface of the porous body may be less than or equal to 0.4. A ratio of the length of the liquid absorption surface of the porous body to the length of the heating surface of the porous body may be less than or equal to 0.3. A ratio of the length of the liquid absorption surface of the porous body to the length of the heating surface of the porous body may be less than or equal to 0.2.

A ratio of the length of the liquid absorption surface of the porous body to the length of the heating surface of the porous body may be at least 0.1. A ratio of the length of the liquid absorption surface of the porous body to the length of the heating surface of the porous body may be at least 0.2. A ratio of the length of the liquid absorption surface of the porous body to the length of the heating surface of the porous body may be at least 0.3. A ratio of the length of the liquid absorption surface of the porous body to the length of the heating surface of the porous body may be at least 0.4. A ratio of the length of the liquid absorption surface of the porous body to the length of the heating surface of the porous body may be at least 0.5. A ratio of the length of the liquid absorption surface of the porous body to the length of the heating surface of the porous body may be at least 0.6. A ratio of the length of the liquid absorption surface of the porous body to the length of the heating surface of the porous body may be at least 0.7. A ratio of the length of the liquid absorption surface of the porous body to the length of the heating surface of the porous body may be at least 0.8.

A ratio of the length of the liquid absorption surface of the porous body to the length of the heating surface of the porous body may be between 0.1 and 0.9. A ratio of the length of the liquid absorption surface of the porous body to the length of the heating surface of the porous body may be between 0.2 and 0.8. A ratio of the length of the liquid absorption surface of the porous body to the length of the heating surface of the porous body may be between 0.3 and 0.7. A ratio of the length of the liquid absorption surface of the porous body to the length of the heating surface of the porous body may be between 0.4 and 0.6.

The liquid absorption surface of the porous body may have a width or a length that is less than a width of the heating surface of the porous body.

The heating surface of the porous body may have a perimeter that is greater than the perimeter of the liquid absorption surface of the porous body. The liquid absorption surface of the porous body may have a perimeter that is less than the perimeter of the heating surface of the porous body.

The heating surface of the porous body may have a diameter that is greater than the diameter of the liquid absorption surface of the porous body. The liquid absorption surface of the porous body may have a diameter that is less than the diameter of the heating surface of the porous body.

A ratio of the diameter of the liquid absorption surface of the porous body to the diameter of the heating surface of the porous body may be less than or equal to 0.9. A ratio of the diameter of the liquid absorption surface of the porous body to the diameter of the heating surface of the porous body may be less than or equal to 0.8. A ratio of the diameter of the liquid absorption surface of the porous body to the diameter of the heating surface of the porous body may be less than or equal to 0.7. A ratio of the diameter of the liquid absorption surface of the porous body to the diameter of the heating surface of the porous body may be less than or equal to 0.6. A ratio of the diameter of the liquid absorption surface of the porous body to the diameter of the heating surface of the porous body may be less than or equal to 0.5. A ratio of the diameter of the liquid absorption surface of the porous body to the diameter of the heating surface of the porous body may be less than or equal to 0.4. A ratio of the diameter of the liquid absorption surface of the porous body to the diameter of the heating surface of the porous body may be less than or equal to 0.3. A ratio of the diameter of the liquid absorption surface of the porous body to the diameter of the heating surface of the porous body may be less than or equal to 0.2.

A ratio of the diameter of the liquid absorption surface of the porous body to the diameter of the heating surface of the porous body may be at least 0.1. A ratio of the diameter of the liquid absorption surface of the porous body to the diameter of the heating surface of the porous body may be at least 0.2. A ratio of the diameter of the liquid absorption surface of the porous body to the diameter of the heating surface of the porous body may be at least 0.3. A ratio of the diameter of the liquid absorption surface of the porous body to the diameter of the heating surface of the porous body may be at least 0.4. A ratio of the diameter of the liquid absorption surface of the porous body to the diameter of the heating surface of the porous body may be at least 0.5. A ratio of the diameter of the liquid absorption surface of the porous body to the diameter of the heating surface of the porous body may be at least 0.6. A ratio of the diameter of the liquid absorption surface of the porous body to the diameter of the heating surface of the porous body may be at least 0.7. A ratio of the diameter of the liquid absorption surface of the porous body to the diameter of the heating surface of the porous body may be at least 0.8.

A ratio of the diameter of the liquid absorption surface of the porous body to the diameter of the heating surface of the porous body may be between 0.1 and 0.9. A ratio of the diameter of the liquid absorption surface of the porous body to the diameter of the heating surface of the porous body may be between 0.2 and 0.8. A ratio of the diameter of the liquid absorption surface of the porous body to the diameter of the heating surface of the porous body may be between 0.3 and 0.7. A ratio of the diameter of the liquid absorption surface of the porous body to the diameter of the heating surface of the porous body may be between 0.4 and 0.6.

The heating surface of the porous body may have a circumference that is greater than the circumference of the liquid absorption surface of the porous body. The liquid absorption surface of the porous body may have a circumference that is less than the circumference of the heating surface of the porous body.

The porous body may comprise a shape that tapers from the heating surface of the porous body towards the liquid absorption surface of the porous body. The porous body may comprise a shape that tapers from the heating surface of the porous body to the liquid absorption surface of the porous body.

The heating surface of the porous body may be convex in one or both of a first transverse direction and a second transverse direction, the first transverse direction being orthogonal to the second transverse direction.

Inclusion of such a porous ceramic body may enable the surface area of the heating surface to be increased without increasing the width of the heating surface. This may increase the efficiency of the aerosol-generating system at vaporising liquid aerosol-forming substrate, whilst helping to avoid the need to redesign other components of the aerosol-generating system to accommodate the porous ceramic body.

The provision of a heating surface that is convex along one or both of a first transverse direction and a second transverse direction may help to avoid or minimise recirculation of airflow adjacent the heater assembly. In particular, a heating surface that is convex may help to avoid or minimise recirculation of airflow adjacent to a central region of the heater assembly. This may reduce a level of turbulence in the airflow adjacent to the heater assembly. Reducing a level of turbulence in the airflow adjacent to the heater assembly may improve the entrainment of vapour of aerosol-forming substrate in the airflow. This may improve the quality of the aerosol generated by the aerosol-generating system.

Improving the entrainment of vapour in the airflow through the aerosol-generating system may avoid or reduce vapour condensing to form large droplets of liquid aerosol-forming substrate. This may help to avoid an unpleasant and undesirable user experience.

Improving the entrainment of vapour in the airflow through the aerosol-generating system may avoid or reduce vapour condensing on internal surfaces of the aerosol-generating system. This may help to avoid or minimise damage to the aerosol-generating system and may allow optimal function of the aerosol-generating system.

The heating surface of the porous body may be convex in a single transverse direction.

The heating surface of the porous body may be convex in both the first transverse direction and the second transverse direction.

The heating surface of the porous body may be convex in one or both of the first transverse direction and the second transverse direction based on the configuration of the heater assembly relative to one or more airflow pathways of the aerosol-generating system.

The heater assembly may be configured to minimise a level of turbulence in the airflow adjacent to the heater assembly. For example, it may be advantageous for the heater assembly to be arranged in the aerosol-generating system such that air drawn into the aerosol-generating system follows a curved path along at least a portion of a curved surface of the heater assembly.

The heating element may be convex in one or both of the first transverse direction and the second transverse direction.

The curvature of the heating element in the first transverse direction may be substantially the same as the curvature of the heating surface of the porous body in the first transverse direction. The curvature of the heating element in the second transverse direction may be substantially the same as the curvature of the heating surface of the porous body in the second transverse direction. The curvature of the heating element in both the first transverse direction and the second transverse direction may be substantially the same as the curvature of the heating surface of the porous body in both the first transverse direction and the second transverse direction, respectively.

The porous body may be a porous ceramic body. The heater assembly may comprise a thermally insulating layer. The thermally insulating layer may have a lower thermal conductivity than the porous ceramic body. The thermally insulating layer may be disposed between each of the porous ceramic body and the heating element. The thermally insulating layer may be in contact with each of the porous ceramic body and the heating element. The thermally insulating layer may be configured to reduce heat transfer from the heating element to the porous ceramic body.

The thermally insulating layer may comprise a thermally insulating material. The thermally insulating material may have a lower thermal conductivity than the porous ceramic body. The thermally insulating material may have a higher porosity than the porous ceramic body. This has the advantage of providing a thermally insulating layer which is particularly effective at reducing energy losses, while being easy to manufacture.

The thermally insulating layer may comprise a material having a thermal conductivity of less than 40 Watts per metre-Kelvin. This has the advantage of providing a thermally insulating layer which is effective at reducing energy losses through the porous ceramic body. The thermally insulating layer may comprise a material having a thermal conductivity of less than 10 Watts per metre-Kelvin. This has the advantage of providing a thermally insulating layer which is particularly effective at reducing energy losses through the porous ceramic body.

The thermally insulating layer may extend entirely between the porous ceramic body and the heating element. This has the advantage of more effectively providing a barrier between the heating element and the porous ceramic body, and as such is particularly effective at reducing energy losses through the porous ceramic body.

The thermally insulating layer may comprise one or more of: alumina, zirconia, zirconia with magnesium oxide, glass ceramic, quartz, a porous polymer. The porous polymer may be polyimide.

The thermally insulating layer may comprise alumina having a thermal conductivity of 20-40 Watts per metre-Kelvin. The thermally insulating layer may comprise a material having a thermal conductivity of less than 10 Watts per metre-Kelvin, such as zirconia with or without magnesium oxide, glass ceramics, quartz. Use of alumina, zirconia with or without magnesium oxide, glass ceramics, quartz, is advantageous, as these materials are compatible with a manufacturing process involving sintering, and as such a heater assembly having a thermally insulating layer of one of these materials is more easily manufactured.

The thermally insulating layer may have a thickness of between 0.1 millimetres and 2 millimetres. A thermally insulating layer with such a thickness is particularly suited to reducing energy losses from the heating element to the porous ceramic body. Preferably, the thermally insulating layer has a thickness of between 0.5 millimetres and 1.5 millimetres. A thermally insulating layer with such a thickness is further suited to reducing energy losses from the heating element to the porous ceramic body.

The average pore size of the porous body may vary between the liquid absorption surface and the heating surface.

The provision of a porous body which includes a variation of pore size between the liquid absorption surface and the heating surface may advantageously help to control the transport of liquid aerosol-forming substrate from a reservoir of liquid aerosol-forming substrate to the heating element. Specifically, the variation of pore size between the liquid absorption surface and the heating surface may allow the porous body to provide a consistent supply of aerosol-forming substrate to the heating surface. This may advantageously avoid undesirable “dry heating”. In addition, the porous body of the present invention may also advantageously prevent leakage of liquid aerosol-forming substrate from the heating surface of the porous body.

The average pore size of the porous body may vary in any way between the liquid absorption surface and the heating surface. The average pore size may vary from relatively larger pores at the liquid absorption surface to relatively smaller pores at the heating surface.

The provision of a porous body having a larger average pore size at the liquid absorption end, and a smaller average pore size at a heating end may particularly facilitate efficient transfer of liquid aerosol-forming substrate from the liquid absorption end of the porous body to the heating end of the porous body without allowing leakage. In particular, the inventors of the present invention have identified that liquid aerosol-forming substrate is transferred from the liquid absorption end of the porous body to the heating end of the porous body by capillary action. How rapidly the liquid aerosol-forming substrate moves through the porous body depends on a number of factors including, but not limited to, the geometry of the pores, the surface tension between the liquid aerosol-forming substrate and the porous body, the viscosity of the liquid aerosol-forming substrate, the surface tension of the liquid aerosol-forming substrate. The inventors of the present invention have identified the need to balance these factors to provide efficient transfer of liquid aerosol-forming substrate to the heating surface of the porous body while preventing leakage of the liquid aerosol-forming substrate.

Firstly, in order to provide an efficient capillary flow of liquid through the porous body, the capillary pressure must overcome the viscous drag pressure. Secondly, to prevent leakage, inertial forces must not overcome the capillary pressure. These two requirements are realised by providing a porous body with larger pores at the liquid absorption end and smaller pores at the heating end.

In particular, the inventors of the present invention have realised that the viscosity of the liquid aerosol-forming substrate varies with temperature. In particular, the viscosity of the liquid aerosol-forming substrate decreases as its temperature increases. As a result, as the liquid aerosol-forming substrate moves through the porous body from the liquid absorption surface to the heating surface, the viscosity of the liquid aerosol-forming substrate decreases. Since the liquid aerosol-forming substrate is transported through the porous body by capillary forces, the capillary force needs to overcome the viscous drag of the liquid. The viscous drag decreases as viscosity decreases. As a result, the capillary force needed to move the liquid aerosol-forming substrate can decrease towards the heating surface of the porous body while still maintaining the same flow rate. Consequently, the average pore size of the porous body can decrease towards the heating surface without reducing the flow of liquid aerosol-forming substrate through the porous body.

The heating element may comprise a plurality of tracks or track portions arranged electrically in parallel. The heating element resistance at room temperature may be between 0.5 Ohms and 1.5 Ohms, preferably between 0.7 Ohms and 1.3 Ohms, and more preferably 1 Ohm. The resistance of the heating element may be matched to requirements of control electronics.

At least two of the electrically parallel heating tracks may have similar resistances to each other, or have the same resistance as each other. Preferably, all of the electrically parallel heating tracks are of similar or of the same resistance as each other. The heating tracks arranged electrically in parallel may have different resistances, which is particularly beneficial in a heater assembly where it is advantageous for zones of the heating element to generate different power levels. This could be the case, for example, to compensate for higher thermal losses in an outer part of the heating element. As such, heating tracks on an exterior or outer part of the heating element may be designed to have a lower resistance (which can generate more heat) than heating tracks in the centre of the heating element.

The heating element may comprise a plurality of tracks or track portions. The plurality of tracks or track portions may be arranged electrically in parallel. By being arranged electrically in parallel, current flow is split into separate parallel flow paths, the separate parallel flow paths being subsequently re-combined.

The heating element may comprise a first connecting pad and a second connecting pad. The first or second connecting pads (or first and second connecting pads) may be configured to allow connection to an external circuit. An aperture or plurality of apertures in the heating element may separate each track or track portion. The heating element may comprise at least one diverging portion, in which current is split from the first connecting pad into track portions. The track portions define electrically parallel paths. The heating element may comprise a converging portion. In the converging portion, current is combined from track portions which define electrically parallel paths, into the second connecting pad.

Various different arrangements are possible of tracks or track portions arranged electrically in parallel. The heating element may comprise two, three, four or more track portions which define electrically parallel paths.

By having tracks or track portions arranged electrically in parallel, if one track portion is defective, current can be redistributed and can still flow through the heating element, i.e. the electrical connection between the first connecting pad and the second connecting pad is not broken. In contrast, in a simple serpentine heater defining a single electrical path between the first connecting pad and the second connecting pad, if a part of the serpentine heating element is broken or contains a defect, this can cause an increase in local resistance, causing increased power dissipation, which in turn increases the resistance until breakage.

The inventors have also identified that the electrically parallel tracks or track portions have a surprising additional advantage. In such an arrangement, in case of breakage of one track portion, the heating element will still operate and can, for an initial transitory period, operate in an advantageous way because the breakage of one track or track portion would result in a higher energy density on the remaining tracks or track portions. In such a case, the same power would still be provided but over a smaller area, so throughput of the aerosol-generating substrate is increased. Such a breakage causing an increase in current on unbroken tracks or track portions can eventually affect the user's experience. This can be mitigated for by a mechanism to alert the user about possible future below optimal performance of the heater assembly. Electrically parallel tracks have the advantage of increasing the number of puffs before full failure of the heater, and potentially increasing the heater lifetime up to the lifetime of the device.

The heating element may comprise a plurality of tracks or track portions defining a path having at least one bend, the inner edge of the bend being curved.

The inner edge of the bend being curved has the advantage of guiding current to flow in a more evenly distributed way around the at least one bend. This reduces a current concentration which in turn limits hot spot creation.

The heating element may comprise a plurality of tracks or track portions having a gradient of electrical resistivity perpendicular to current flow in a corner or corners, such that the electrical resistivity is higher at an inner part of the corner and lower at an outer part of the corner. Such a gradient is beneficial to counterbalance localized high current density and reduce hot spot creation.

The heating element may comprise a plurality of tracks or track portions arranged with a distance between at least two of the plurality of tracks or track portions in the range 200 150 to 300 micrometres.

All of the tracks or track portions may be spaced apart from at least one other track portion by 200 to 300 micrometres. This may have the advantage of providing a particularly efficient heater assembly, in which an aerosol-forming substrate is efficiently vaporised.

According to an example of the present disclosure, there is provided an aerosol-generating system. The aerosol-generating system may comprise a heater assembly as discussed above. The heating element may be fluid permeable such that, in use, vapour is emitted from the heater assembly in an average vapour emission direction. The aerosol-generating system may further comprise an air inlet and an aerosol outlet. The air inlet may be in fluid communication with the aerosol outlet to define an airflow pathway through the aerosol-generating system. The heater assembly may be arranged in fluid communication with the airflow pathway such that air flows past the heater assembly in an average airflow direction. The heater assembly and airflow pathway may be arranged such that an angle between the average vapour emission direction and the average airflow direction is less than 135 degrees.

Advantageously, by arranging the heater assembly and airflow pathway such that the angle between the average vapour emission direction and the average airflow direction is less than 135 degrees, the average airflow direction does not directly oppose the average vapour emission direction. Therefore, the momentum of the vapour and the airflow is not reduced to the same extent as when the average airflow direction does directly oppose the average vapour emission direction. This reduces the tendency for recirculation and turbulence to occur in the airflow path and the vapour is less likely to impinge on the internal surfaces of the aerosol-generating system. Accordingly, condensation of aerosol within the aerosol-generating system is less likely to occur.

The average vapour emission direction may be substantially perpendicular to the heating surface. As used herein, the term “substantially perpendicular” means 90 degrees plus or minus 10 degrees, preferably plus or minus 5 degrees.

An advantage of the average vapour emission direction being substantially perpendicular to the heating surface is that it makes orientating the average vapour emission direction relative to the average airflow direction straightforward because the vapour will be emitted substantially perpendicular to the heating surface of the porous body. Therefore, by angling the heater assembly appropriately relative to the airflow in the airflow pathway or vice versa, a desired angle between the average vapour emission direction and average airflow direction can be achieved.

The heater assembly and airflow pathway may be arranged such that an angle between the average vapour emission direction and the average airflow direction is less than 110 degrees, preferably less than 100 degrees.

The heater assembly and airflow pathway may be arranged such that an angle between the average vapour emission direction and the average airflow direction is approximately 90 degrees. This arrangement results in the vapour being emitted at an angle substantially perpendicular to the average airflow direction. The average vapour emission direction has no speed or direction component that opposes the airflow direction and therefore any loss of momentum of the airflow is reduced. This reduces the tendency for recirculation and turbulence to occur in the airflow path and the vapour is less likely to impinge on the internal surfaces of the aerosol-generating system. Furthermore, entrainment of the vapour in the airflow is improved. Accordingly, condensation of aerosol within the aerosol-generating system is less likely to occur.

The heater assembly and airflow pathway may be arranged such that an angle between the average vapour emission direction and the average airflow direction is less than 90 degrees. In this arrangement, the average vapour emission direction has no speed or direction component that opposes the airflow direction and actually has a speed and direction component in the same direction as the average airflow direction. Therefore, any loss of momentum of the airflow is further reduced. This reduces the tendency for recirculation and turbulence to occur in the airflow path and the vapour is less likely to impinge on the internal surfaces of the aerosol-generating system. Furthermore, entrainment of the vapour in the airflow is improved. Accordingly, condensation of aerosol within the aerosol-generating system is less likely to occur.

The heater assembly and airflow pathway may be arranged such that an angle between the average vapour emission direction and the average airflow direction is approximately 45 degrees. The heater assembly and airflow pathway may be arranged such that an angle between the average vapour emission direction and the average airflow direction is less than 45 degrees.

The heater assembly and airflow pathway may be arranged such that the average vapour emission direction and the average airflow direction are substantially the same. In this arrangement, there is virtually no loss of momentum of the airflow as the average vapour emission direction and average airflow direction are the same. This reduces the tendency for recirculation and turbulence to occur in the airflow path and the vapour is less likely to impinge on the internal surfaces of the aerosol-generating system. Furthermore, entrainment of the vapour in the airflow is improved. Accordingly, condensation of aerosol within the aerosol-generating system is less likely to occur.

A cross-sectional area of the airflow pathway in the region of the heater assembly may be configured such that, in use, the airflow speed is between 0.1 and 2 metres per second, preferably between 0.5 and 1.5 metres per second and more preferably approximately 1 metre per second. This range of airflow speeds has been found to effectively entrain the vapour emitted from different designs of heating element without excessively cooling the heating element.

The heating element may comprise a porous layer of electrically conductive material. Advantageously, a heating element comprising a porous layer of electrically conductive material allows an electrical current to flow through the heating element such that the heating element can be resistively heated and also allows vapours to travel through the heating element via the pores in its porous structure. Thus vapour emission occurs through the porous heating element. This avoids the build-up of vapour pressure underneath the heating element and high speed vapour emission at the sides of the heating element. The inventors have found that this arrangement produces a consistent vapour across the heating element and a lower vapour emission speed of approximately 0.1 metres per second. Such a low vapour emission speed means that the vapour is easily carried away by the airflow reducing the impingement of vapour on the internal walls of the aerosol-generating system.

According to an example of the present disclosure, there is provided a cartridge. The cartridge may comprise a heater assembly. The cartridge may comprise a liquid storage portion for holding an aerosol-forming substrate. The heater assembly may comprise a heating element for vaporising the liquid aerosol-forming substrate. The heater assembly may comprise a porous body for conveying the liquid aerosol-forming substrate to the heating element. The porous body may have a liquid absorption surface. The porous body may have a heating surface. The heating element may be located on the heating surface of the porous body. The liquid absorption surface of the porous body may have an area that is different to an area of the heating surface of the porous body. The porous body may comprise a porous ceramic body or a porous glass body.

According to an example of the present disclosure, there is provided a cartridge, the cartridge comprising a heater assembly and a liquid storage portion for holding a liquid aerosol-forming substrate, the heater assembly comprising: a heating element for vaporising the liquid aerosol-forming substrate; and a porous body for conveying the liquid aerosol-forming substrate to the heating element, the porous body having a liquid absorption surface and a heating surface, the heating element being located on the heating surface of the porous body, wherein the liquid absorption surface of the porous body has an area that is different to an area of the heating surface of the porous body, and wherein the porous body comprises a porous ceramic body or a porous glass body.

The cartridge may comprise the liquid aerosol-forming substrate in the liquid storage portion. The liquid aerosol-forming substrate may be as described above.

The porous body may be fluidly connected to the liquid storage portion. The liquid absorption surface of the porous body may be fluidly connected to the liquid storage portion.

The liquid storage portion may be arranged at the liquid absorption surface of the porous body.

There is provided an aerosol-generating system. The aerosol-generating system may comprise a cartridge and an aerosol-generating device. The cartridge may comprise a heater assembly. The cartridge may comprise a liquid storage portion for holding an aerosol-forming substrate. The heater assembly may comprise a heating element for vaporising the liquid aerosol-forming substrate. The heater assembly may comprise a porous body for conveying the liquid aerosol-forming substrate to the heating element. The porous body may have a liquid absorption surface. The porous body may have a heating surface. The heating element may be located on the heating surface of the porous body. The liquid absorption surface of the porous body may have an area that is different to an area of the heating surface of the porous body. The porous body may comprise a porous ceramic body or a porous glass body. The aerosol-generating device may comprise a power supply for supplying electrical power to the heating element. The aerosol-generating device may comprise control circuitry configured to control a supply of power from the power supply to the heating element.

There is provided an aerosol-generating system comprising: a cartridge and an aerosol-generating device, the cartridge comprising a heater assembly and a liquid storage portion for holding a liquid aerosol-forming substrate, the heater assembly comprising: a heating element for vaporising the liquid aerosol-forming substrate; and a porous body for conveying the liquid aerosol-forming substrate to the heating element, the porous body having a liquid absorption surface and a heating surface, the heating element being located on the heating surface of the porous body, wherein the liquid absorption surface of the porous body has an area that is different to an area of the heating surface of the porous body, and wherein the porous body comprises a porous ceramic body or a porous glass body. The aerosol-generating devices comprising a power supply for supplying electrical power to the heating element; and control circuitry configured to control a supply of power from the power supply to the heating element.

The cartridge may comprise the liquid aerosol-forming substrate in the liquid storage portion. The liquid aerosol-forming substrate may be as described above.

The aerosol-generating system may be portable. The aerosol-generating system may have a size comparable to a conventional cigar or cigarette.

The cartridge may be removably couplable to the aerosol-generating device.

The aerosol-forming substrate may be liquid at room temperature. The aerosol-forming substrate may comprise both liquid and solid components. The liquid aerosol-forming substrate may comprise nicotine. The nicotine containing liquid aerosol-forming substrate may be a nicotine salt matrix. The liquid aerosol-forming substrate may comprise plant-based material. The liquid aerosol-forming substrate may comprise tobacco. The liquid aerosol-forming substrate may comprise a tobacco-containing material containing volatile tobacco flavour compounds, which are released from the aerosol-forming substrate upon heating. The liquid aerosol-forming substrate may comprise homogenised tobacco material. The liquid aerosol-forming substrate may comprise a non-tobacco-containing material. The liquid aerosol-forming substrate may comprise homogenised plant-based material.

The liquid aerosol-forming substrate may comprise one or more aerosol-formers. An aerosol-former is any suitable known compound or mixture of compounds that, in use, facilitates formation of a dense and stable aerosol and that is substantially resistant to thermal degradation at the temperature of operation of the system. Examples of suitable aerosol formers include glycerine and propylene glycol. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. The liquid aerosol-forming substrate may comprise water, solvents, ethanol, plant extracts and natural or artificial flavours.

The liquid aerosol-forming substrate may comprise nicotine and at least one aerosol-former. The aerosol-former may be glycerine or propylene glycol. The aerosol former may comprise both glycerine and propylene glycol. The liquid aerosol-forming substrate may have a nicotine concentration of between about 0.5% and about 10%, for example about 2%.

The airflow pathway may pass through the liquid storage portion. For example, the liquid storage portion may have an annular cross-section defining an internal passage or aerosol channel, and the airflow pathway may extend through the internal passage passage or aerosol channel of the liquid storage portion.

The cartridge may comprise a cartridge housing. The cartridge housing may be formed from a durable material. The cartridge housing may be formed from a liquid impermeable material. The cartridge housing may be formed form a mouldable plastics material, such as polypropylene (PP) or polyethylene terephthalate (PET) or a copolymer such as Tritan™ which is made from three monomers: dimethyl terephthalate (DMT), cyclohexanedimethanol (CHDM), and 2,2,4,4-tetramethyl-1,3-cyclobutanediol (CBDO). The cartridge housing of the cartridge may define a portion of the liquid storage portion or reservoir. The cartridge housing may define the liquid storage portion. The cartridge housing and the liquid storage portion may be integrally formed. Alternatively, the liquid storage portion may be formed separately from the outer housing and arranged in the outer housing.

The aerosol-generating device may comprise a power supply for supplying power to the heater assembly. The aerosol-generating device may comprise control circuitry for controlling the supply of power from the power supply to the heater assembly. The cartridge may be removably couplable to the aerosol-generating device.

The aerosol-generating device may comprise a housing. The housing may be elongate. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. The material is preferably light and non-brittle.

The aerosol-generating device housing may define a cavity for receiving a portion of a cartridge. The aerosol-generating device may have a connection end configured to connect the aerosol-generating device to a cartridge. The connection end may comprise the cavity for receiving the cartridge.

The power supply may be any suitable power supply. Preferably, the power supply is a DC power supply. The power supply may be a battery. The battery may be a Lithium based battery, for example a Lithium-Cobalt, a Lithium-Iron-Phosphate, a Lithium Titanate or a Lithium-Polymer battery. The battery may be a Nickel-metal hydride battery or a Nickel cadmium battery. The power supply may be another form of charge storage device such as a capacitor. The power supply may be rechargeable and be configured for many cycles of charge and discharge. The power supply may have a capacity that allows for the storage of enough energy for one or more user experiences of the aerosol-generating system; for example, the power supply may have sufficient capacity to allow for the continuous generation of aerosol for a period of around six minutes, corresponding to the typical time taken to smoke a conventional cigarette, or for a period that is a multiple of six minutes. In another example, the power supply may have sufficient capacity to allow for a predetermined number of puffs or discrete activations of the aerosol-generating system.

The control circuitry may comprise any suitable controller or electrical components. The controller may comprise a memory. Information for performing the above-described method may be stored in the memory. The control circuitry may comprise a microprocessor. The microprocessor may be a programmable microprocessor, a microcontroller, or an application specific integrated chip (ASIC) or other electronic circuitry capable of providing control. The control circuitry may be configured to supply power to the heating element continuously following activation of the device, or may be configured to supply power intermittently, such as on a puff-by-puff basis. The power may be supplied to the heating element in the form of pulses of electrical current, for example, by means of pulse width modulation (PWM).

Features described in relation to one of the above examples may equally be applied to other examples of the present disclosure.

The invention is defined in the claims. However, below there is provided a non-exhaustive list of non-limiting examples. Any one or more of the features of these examples may be combined with any one or more features of another example, embodiment, or aspect described herein.

Example Ex1: A heater assembly for an aerosol-generating system, the heater assembly comprising: a heating element for vaporising a liquid aerosol-forming substrate; and
a porous body for conveying the liquid aerosol-forming substrate to the heating element, the porous body having a liquid absorption surface and a heating surface, the heating element being located on the heating surface of the porous body, wherein the liquid absorption surface of the porous body has an area that is different to an area of the heating surface of the porous body, and wherein the porous body comprises a porous ceramic body or a porous glass body.

Example Ex2. A heater assembly according to Example Ex1, wherein the area of the heating surface of the porous body is less than the area of the liquid absorption surface of the porous body.

Example Ex3. A heater assembly according to any preceding Example, wherein a ratio of the area of the heating surface of the porous body to the area of the liquid absorption surface of the porous body is less than or equal to 0.9.

Example Ex4. A heater assembly according to any preceding Example, wherein a ratio of the area of the heating surface of the porous body to the area of the liquid absorption surface of the porous body is at least 0.1.

Example Ex5. A heater assembly according to any preceding Example, wherein a ratio of the area of the heating surface of the porous body to the area of the liquid absorption surface of the porous body is between 0.1 and 0.9.

Example Ex6. A heater assembly according to any preceding Example, wherein the heating surface of the porous body has a width that is less than the width of the liquid absorption surface of the porous body.

Example Ex7. A heater assembly according to Example Ex6, wherein a ratio of the width of the heating surface of the porous body to the width of the liquid absorption surface of the porous body is less than or equal to 0.9.

Example Ex8. A heater assembly according to Example Ex6 or Example Ex7, wherein a ratio of the width of the heating surface of the porous body to the width of the liquid absorption surface of the porous body is at least 0.1.

Example Ex9. A heater assembly according to any of Examples Ex6 to Ex8, wherein a ratio of the width of the heating surface of the porous body to the width of the liquid absorption surface of the porous body is between 0.1 and 0.9.

Example Ex10. A heater assembly according to any preceding Example, wherein the heating surface of the porous body has a length that is less than the length of the liquid absorption surface of the porous body.

Example Ex11. A heater assembly according to Example Ex10, wherein a ratio of the length of the heating surface of the porous body to the length of the liquid absorption surface of the porous body is less than or equal to 0.9.

Example Ex12. A heater assembly according to Example Ex10 or Example Ex11, wherein a ratio of the length of the heating surface of the porous body to the length of the liquid absorption surface of the porous body is at least 0.1.

Example Ex13. A heater assembly according to any of Examples Ex10 to Ex12, wherein a ratio of the length of the heating surface of the porous body to the length of the liquid absorption surface of the porous body is between 0.1 and 0.9.

Example Ex14. A heater assembly according to Example Ex1 or Example Ex2, wherein the heating surface of the porous body has a diameter that is less than the diameter of the liquid absorption surface of the porous body.

Example Ex15. A heater assembly according to Example Ex14, wherein a ratio of the diameter of the heating surface of the porous body to the diameter of the liquid absorption surface of the porous body is less than or equal to 0.9.

Example Ex16. A heater assembly according to Example Ex14 or Example Ex15, wherein a ratio of the diameter of the heating surface of the porous body to the diameter of the liquid absorption surface of the porous body is at least 0.1.

Example Ex17. A heater assembly according to any of Examples Ex14 to Ex16, wherein a ratio of the diameter of the heating surface of the porous body to the diameter of the liquid absorption surface of the porous body is between 0.1 and 0.9.

Example Ex18. A heater assembly according to any preceding Example, wherein the porous body comprises a shape that tapers from the liquid absorption surface of the porous body towards the heating surface of the porous body.

Example Ex19. A heater assembly according to any preceding Example, wherein the porous body has a trapezoid prism shape, or a truncated pyramid shape.

Example Ex20. A heater assembly according to any preceding Example, wherein the heating surface has an area of at least 1 square millimetre.

Example Ex21. A heater assembly according to any preceding Example, wherein the heating surface has an area of less than or equal to 30 square millimetres.

Example Ex22. A heater assembly according to any preceding Example, wherein the heating surface has an area of between 1 square millimetre and 30 square millimetres.

Example Ex23. A heater assembly according to any preceding Example, wherein the liquid absorption surface has an area of at least 2 square millimetres.

Example Ex24. A heater assembly according to any preceding Example, wherein the liquid absorption surface has an area of less than or equal to 100 square millimetres.

Example Ex25. A heater assembly according to any preceding Example, wherein the liquid absorption surface has an area of between 2 square millimetres and 100 square millimetres.

Example Ex26. A heater assembly according to Example Ex1, wherein the area of the liquid absorption surface of the porous body is less than the area of the heating surface of the porous body.

Example Ex27. A heater assembly according to Example Ex26, wherein a ratio of the area of the liquid absorption surface of the porous body to the area of the heating surface of the porous body is less than or equal to 0.9.

Example Ex28. A heater assembly according to Example Ex26 or Ex27, wherein a ratio of the area of the liquid absorption surface of the porous body to the area of the heating surface of the porous body is at least 0.1.

Example Ex29. A heater assembly according to any of Examples Ex26 to Ex28, wherein a ratio of the area of the liquid absorption surface of the porous body to the area of the heating surface of the porous body is between 0.1 and 0.9.

Example Ex30. A heater assembly according to any of Examples Ex26 to Ex29, wherein the liquid absorption surface of the porous body has a width that is less than a width of the heating surface of the porous body.

Example Ex31. A heater assembly according to Example Ex30, wherein a ratio of the width of the liquid absorption surface of the porous body to the width of the heating surface of the porous body is less than or equal to 0.9.

Example Ex32. A heater assembly according to Example Ex30 or Example Ex31, wherein a ratio of the width of the liquid absorption surface of the porous body to the width of the heating surface of the porous body is at least 0.1.

Example Ex33. A heater assembly according to any of Examples Ex30 to Ex32, wherein a ratio of the width of the liquid absorption surface of the porous body to the width of the heating surface of the porous body is between 0.1 and 0.9.

Example Ex34. A heater assembly according to any of Examples Ex26 to Ex33, wherein the liquid absorption surface of the porous body has a length that is less than a length of the heating surface of the porous body.

Example Ex35. A heater assembly according to Example Ex34, wherein a ratio of the length of the liquid absorption surface of the porous body to the length of the heating surface of the porous body is less than or equal to 0.9.

Example Ex36. A heater assembly according to Example Ex34 or Example Ex35, wherein a ratio of the length of the liquid absorption surface of the porous body to the length of the heating surface of the porous body is at least 0.1.

Example Ex37. A heater assembly according to any of Examples Ex34 to Ex36, wherein a ratio of the length of the liquid absorption surface of the porous body to the length of the heating surface of the porous body is between 0.1 and 0.9.

Example Ex38. A heater assembly according to Example Ex26, wherein the liquid absorption surface of the porous body has a diameter that is less than a diameter of the heating surface of the porous body.

Example Ex39. A heater assembly according to Example Ex38, wherein a ratio of the diameter of the liquid absorption surface of the porous body to the diameter of the heating surface of the porous body is less than or equal to 0.9.

Example Ex40. A heater assembly according to Example Ex38 or Example Ex39, wherein a ratio of the diameter of the liquid absorption surface of the porous body to the diameter of the heating surface of the porous body is at least 0.1.

Example Ex41. A heater assembly according to any of Examples Ex38 to Ex40, wherein a ratio of the diameter of the liquid absorption surface of the porous body to the diameter of the heating surface of the porous body is between 0.1 and 0.9.

Example Ex42. A heater assembly according to any of Examples Ex26 to Ex41, wherein the porous body comprises a shape that tapers from the heating surface of the porous body towards the liquid absorption surface of the porous body.

Example Ex43. A heater assembly according to any of Examples Ex26 to Ex31, wherein the porous body has a trapezoid prism shape, or a truncated pyramid shape.

Example Ex44. A heater assembly according to any one of Examples Ex26 to Ex43, wherein the liquid absorption surface has an area of at least 1 square millimetre.

Example Ex45. A heater assembly according to any one of Examples Ex26 to Ex44, wherein the liquid absorption surface has an area of less than or equal to 30 square millimetres.

Example Ex46. A heater assembly according to any one of Examples Ex26 to Ex45, wherein the liquid absorption surface has an area of between 1 square millimetre and 30 square millimetres.

Example Ex47. A heater assembly according to any one of Examples Ex26 to Ex46, wherein the heating surface has an area of at least 2 square millimetres.

Example Ex48. A heater assembly according to any one of Examples Ex26 to Ex47, wherein the heating surface has an area of less than or equal to 100 square millimetres.

Example Ex49. A heater assembly according to any one of Examples Ex26 to Ex48, wherein the heating surface has an area of between 2 square millimetres and 100 square millimetres.

Example Ex50. A heater assembly according to any preceding Example, wherein the heating surface of the porous body is convex in one or both of a first transverse direction and a second transverse direction, the first transverse direction being orthogonal to the second transverse direction.

Example Ex51. A heater assembly according to any preceding Example, wherein the average pore size of the porous body varies between the liquid absorption surface and the heating surface.

Example Ex52. A heater assembly according to Example Ex51, wherein the porous body has a heating end and a liquid absorption end, the heating surface being disposed at the heating end, and the liquid absorption surface being disposed at the liquid absorption end, wherein the porous body has a first average pore size at the liquid absorption end, and a second average pore size at the heating end, first average pore size being greater than the second average pore size.

Example Ex53. A heater assembly according to any preceding Example, comprising a thermally insulating layer having a lower thermal conductivity than the porous ceramic body, wherein the thermally insulating layer is disposed between and is in contact with each of the porous ceramic body and the heating element, and the thermally insulating layer is configured to reduce heat transfer from the heating element to the porous ceramic body.

Example Ex54. The heater assembly according to any preceding Example, wherein the heating element comprises a plurality of tracks or track portions arranged electrically in parallel.

Example Ex55. The heater assembly according to any preceding Example, wherein the heating element comprises a plurality of tracks or track portions defining a path having at least one bend, the inner edge of the bend being curved.

Example Ex56. A heater assembly according to any preceding Example, wherein the heating element and the porous body are integrally formed.

Example Ex57. A heater assembly according to any preceding Example, wherein the heating element and the porous body are moulded as a single monolithic piece.

Example Ex58. A heater assembly according to any preceding Example, wherein the heating element is a doped portion of the porous body.

Example Ex59. A heater assembly according to any preceding Example, wherein the heating element is located on and bonded to the heating surface of the porous body.

Example Ex60. A cartridge for an aerosol-generating system, the cartridge comprising: a heater assembly according to any preceding Example; and a liquid storage portion for holding a liquid aerosol-forming substrate, wherein the liquid storage portion is arranged at the liquid absorption surface of the porous body.

Example Ex61. An aerosol-generating system comprising: the cartridge according to Example Ex60; and an aerosol-generating device comprising: a power supply for supplying electrical power to the heating element; and control circuitry configured to control a supply of power from the power supply to the heating element.

Examples will now be further described with reference to the accompanying Figures, wherein:

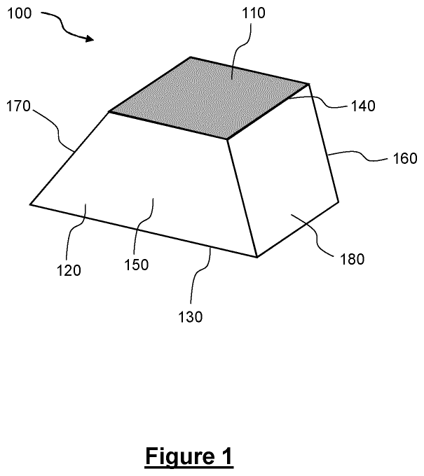

FIG. 1 shows schematically a perspective view of a first example of a heater assembly in accordance with the present disclosure;

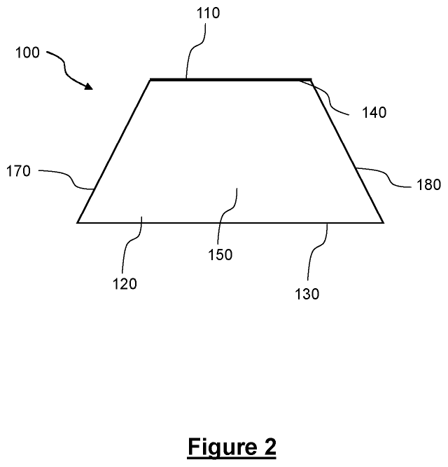

FIG. 2 shows schematically a side view of the first example of the heater assembly shown in FIG. 1;

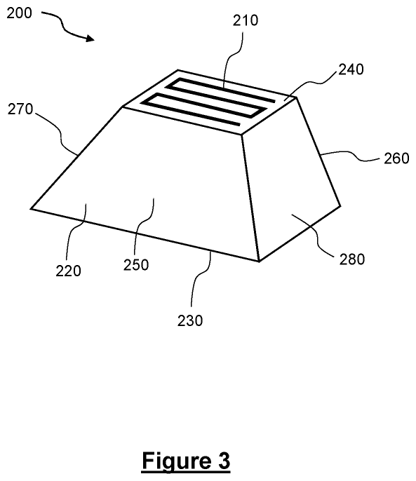

FIG. 3 shows schematically a perspective view of a second example of a heater assembly in accordance with the present disclosure;

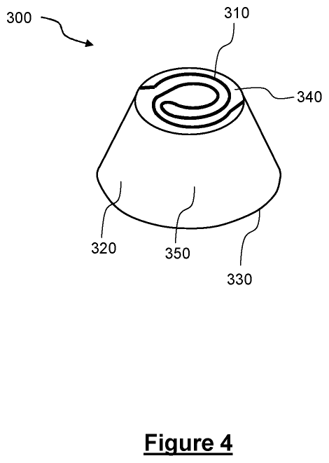

FIG. 4 shows schematically a perspective view of a third example of a heater assembly in accordance with the present disclosure;

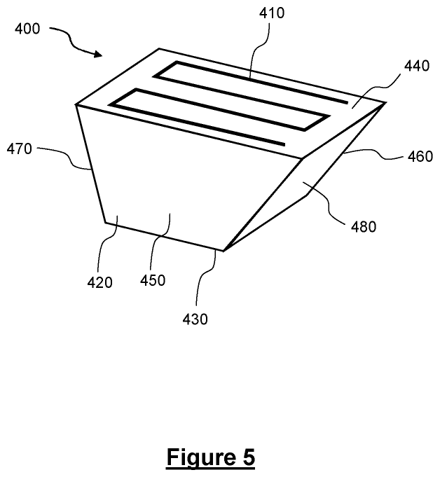

FIG. 5 shows schematically a perspective view of a fourth example of a heater assembly in accordance with the present disclosure;

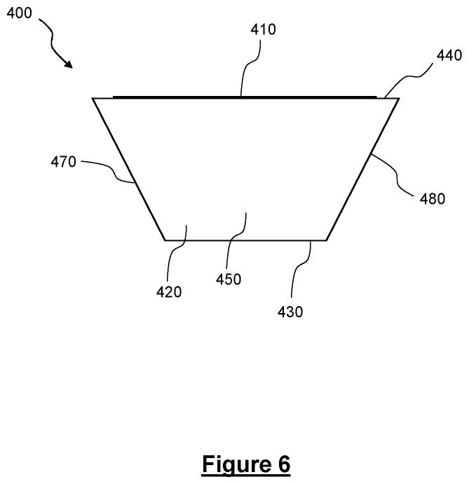

FIG. 6 shows schematically a side view of the fourth example of the heater assembly shown in FIG. 5;

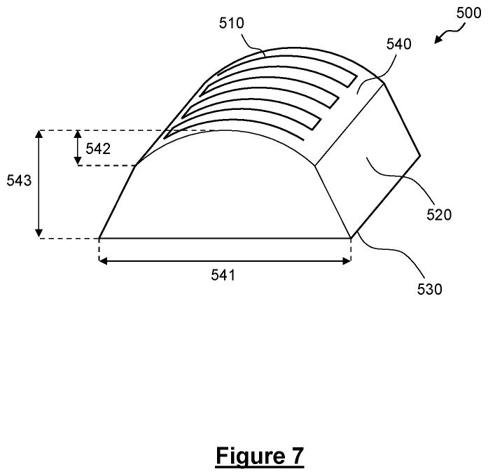

FIG. 7 shows schematically a perspective view of a fifth example of a heater assembly in accordance with the present disclosure;

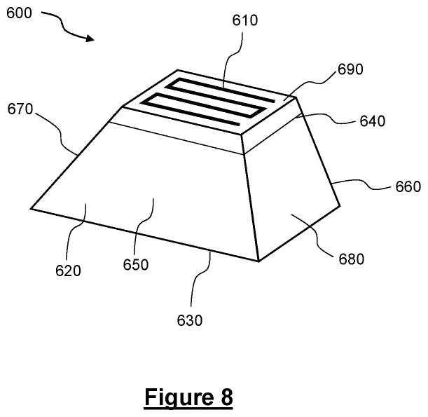

FIG. 8 shows schematically a perspective view of a sixth example of a heater assembly in accordance with the present disclosure;

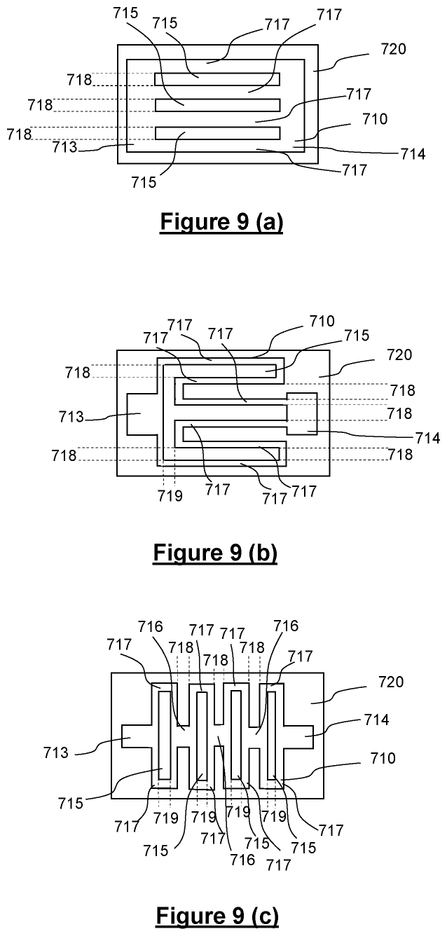

FIGS. 9 (a), 9 (b) and 9 (c) show schematically examples of heating element tracks in accordance with the present disclosure;

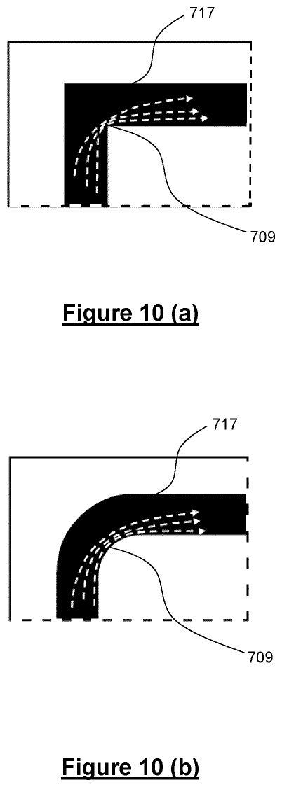

FIGS. 10 (a) and 10 (b) show schematically examples of current flow around a corner of a heating element track in accordance with the present disclosure; and

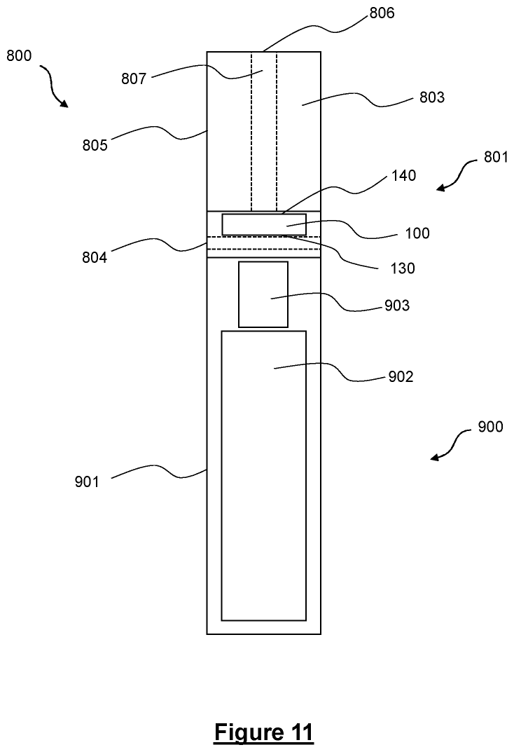

FIG. 11 shows schematically a cross sectional view of an aerosol-generating system in accordance with the present disclosure.

FIGS. 1 and 2 show a schematic illustration of a first example of a heater assembly 100 for an aerosol-generating system. The heater assembly includes a heating element 110 and a porous body 120.

The heating element 110 is configured to vaporise an aerosol-forming substrate, such as a liquid aerosol-forming substrate, to form an aerosol. The heating element 110 is configured to convert electrical energy into heat energy by material resistance of the heating element 110 to an electrical current.

The porous body 120 is configured to convey the liquid aerosol-forming substrate to the heating element 110. In other words, the porous body 120 supplies the liquid aerosol-forming substrate to the heating element 110.

The porous body 120 has a first end face and an opposing second end face. The first end face is a liquid absorption surface 130 and the second end face is a heating surface 140.

In this example, the liquid absorption surface 130 and the heating surface 140 are both substantially flat surfaces. The porous body 120 also has a plurality of lateral faces extending between the liquid absorption surface 130 and the heating surface 140.

In this example, as will be discussed in more detail below, the porous body 120 has a first lateral face 150 opposing a second lateral face 160, and a third lateral face 170 opposing a fourth lateral face 180.

The porous body 120 comprises a plurality of pores. The plurality of pores are open pores. The plurality of pores are interconnected to provide a fluid pathway for liquid aerosol-forming substrate through the porous body 120, from the liquid absorption surface 130 to the heating surface 140. The porous body 120 is formed from a material that does not chemically interact with the liquid aerosol-forming substrate. In this example, the porous body 120 is a porous ceramic body and may be formed from, for example, Ca₂SiO₃ or SiO₂ (or Ca₂SiO₃ and SiO₂). In another example, the porous body 120 may be, for example, a porous glass body.

The heating element 110 is located on the heating surface 140 of the porous body 120. In the example of FIGS. 1 and 2, the heating element 110 is a porous film that extends across substantially all of the heating surface 140.

The liquid absorption surface 130 of the porous body 120 has an area that is different to an area of the heating surface 140 of the porous body 120. Specifically, in the example of FIGS. 1 and 2, the area of the heating surface 140 is less than the area of the liquid absorption surface 130.

In the example of FIGS. 1 and 2, the heating surface 140 has smaller area than the liquid absorption surface 130 because the length of the heating surface 140 is less than the length of the liquid absorption surface 130. In addition, or alternatively, in another example, the heating surface 140 may have a smaller area than the liquid absorption surface 130 because the width of the heating surface 140 is less than the width of the liquid absorption surface 130.

In the example of FIGS. 1 and 2, the porous body 120 is shaped as a trapezoid prism. With the porous body 120 having a trapezoid prism shape, the first lateral face 150 and the second lateral face 160 both have a trapezium shape, specifically an isosceles trapezoid, the third lateral face 170 and the fourth lateral face 180 both have a rectangle shape, and the liquid absorption surface 130 and the heating surface 140 both have a rectangle shape. In another example, the liquid absorption surface 130 and the heating surface 140 may have a square shape.

The porous body 120 tapers from the liquid absorption surface 130 towards the heating surface 140. In other words, the cross-sectional area of the porous body 120 gradually becomes smaller from the liquid absorption surface 130 towards the heating surface 140. In the example of FIGS. 1 and 2, the length of the porous body 120 decreases from the liquid absorption surface 130 towards the heating surface 140 which causes the tapering.

In the example of FIGS. 1 and 2, the pore size of the pores the porous body 120 is the same between the liquid absorption surface 130 and the heating surface 140.

In an alternative example, the pore size of the pores in the porous body 120 vary between the liquid absorption surface 130 and the heating surface 140.

The porous body 120 may include a heating end and a liquid absorption end, the heating surface 140 being disposed at the heating end, and the liquid absorption surface 130 being disposed at the liquid absorption end. The porous body may include a first average pore size at the liquid absorption end, and a second average pore size at the heating end. The first average pore size is greater than the second average pore size.

In this alternative example, the first pore size at the liquid absorption end is about 150 micrometres. The second pore size at the heating end is about 20 micrometres. The pore size varies linearly between the first pore size and the second pore size to provide a pore size gradient between the liquid absorption end and the heating end of the porous body 120.

The pore structure and pore size gradient in the porous body 120 is achieved by etching the pores into a portion of silicon carbide.

FIG. 3 shows a schematic illustration of a second example of a heater assembly 200 for an aerosol-generating system. The heater assembly includes a heating element 210 and a porous body 220.

The heating element 210 is configured to vaporise an aerosol-forming substrate, such as a liquid aerosol-forming substrate, to form an aerosol. The heating element 210 is configured to convert electrical energy into heat energy by material resistance of the heating element 210 to an electrical current.

The porous body 220 is configured to convey the liquid aerosol-forming substrate to the heating element 210. In other words, the porous body 220 supplies the liquid aerosol-forming substrate to the heating element 210.

The porous body 220 has a first end face and an opposing second end face. The first end face is a liquid absorption surface 230 and the second end face is a heating surface 240.

In this example, the liquid absorption surface 230 and the heating surface 240 are both substantially flat surfaces. The porous body 220 also has a plurality of lateral faces extending between the liquid absorption surface 230 and the heating surface 240.

In this example, as will be discussed in more detail below, the porous body 220 has a first lateral face 250 opposing a second lateral face 260, and a third lateral face 270 opposing a fourth lateral face 280.

The porous body 220 comprises a plurality of pores. The plurality of pores are interconnected to provide a fluid pathway for liquid aerosol-forming substrate through the porous body 220, from the liquid absorption surface 230 to the heating surface 240. The porous body 220 is formed from a material that does not chemically interact with the liquid aerosol-forming substrate. In this example, the porous body 220 is a porous ceramic body and may be formed from, for example, Ca₂SiO₃ or SiO₂ (or Ca₂SiO₃ and SiO₂). In another example, the porous body 220 may be, for example, a porous glass body.

The heating element 210 is located on the heating surface 240 of the porous body 220. In the example of FIG. 3, the heating element 210 is an elongate porous film that extends in a meandering pattern across the heating surface 240.

The liquid absorption surface 230 of the porous body 220 has an area that is different to an area of the heating surface 240 of the porous body 220. Specifically, in the example of FIG. 3, the area of the heating surface 240 is less than the area of the liquid absorption surface 230.

In the example of FIG. 3, the heating surface 240 has smaller area than the liquid absorption surface 230 because the width of the heating surface 240 is less than the width of the liquid absorption surface 230, and because the length of the heating surface 240 is less than the length of the liquid absorption surface 230.

In the example of FIG. 3, the porous body 220 is shaped as a truncated pyramid. With the porous body 220 having a truncated pyramid shape, the first lateral face 250 and the second lateral face 260 both have a trapezium shape, the third lateral face 270 and the fourth lateral face 280 both have a trapezium shape, and the liquid absorption surface 230 and the heating surface 240 both have a rectangle shape. In another example, the liquid absorption surface 230 and the heating surface 240 may have a square shape.

The porous body 220 tapers from the liquid absorption surface 230 towards the heating surface 240. In other words, the cross-sectional area of the porous body 220 gradually becomes smaller from the liquid absorption surface 230 towards the heating surface 240. In the example of FIG. 3, both the length and the width of the porous body 220 decrease from the liquid absorption surface 230 towards the heating surface 240, which causes the tapering.

FIG. 4 shows a schematic illustration of a third example of a heater assembly 300 for an aerosol-generating system. The heater assembly includes a heating element 310 and a porous body 320.

The heating element 310 is configured to vaporise an aerosol-forming substrate, such as a liquid aerosol-forming substrate, to form an aerosol. The heating element 310 is configured to convert electrical energy into heat energy by material resistance of the heating element 310 to an electrical current.

The porous body 320 is configured to convey the liquid aerosol-forming substrate to the heating element 310. In other words, the porous body 320 supplies the liquid aerosol-forming substrate to the heating element 310.

The porous body 320 has a first end face and an opposing second end face. The first end face is a liquid absorption surface 330 and the second end face is a heating surface 340. In this example, the liquid absorption surface 330 and the heating surface 340 are both substantially flat surfaces. The porous body 320 also has a lateral face 350 extending between the liquid absorption surface 330 and the heating surface 340.

The porous body 320 comprises a plurality of pores. The plurality of pores are interconnected to provide a fluid pathway for liquid aerosol-forming substrate through the porous body 320, from the liquid absorption surface 330 to the heating surface 340. The porous body 320 is formed from a material that does not chemically interact with the liquid aerosol-forming substrate. In this example, the porous body 320 is a porous ceramic body and may be formed from, for example, Ca₂SiO₃ or SiO₂ (or Ca₂SiO₃ and SiO₂). In another example, the porous body 320 may be, for example, a porous glass body.

The heating element 310 is located on the heating surface 340 of the porous body 320. In the example of FIG. 4, the heating element 310 is an elongate porous film that extends in a meandering pattern around and over the heating surface 340.

The liquid absorption surface 330 of the porous body 320 has an area that is different to an area of the heating surface 340 of the porous body 320. Specifically, in the example of FIG. 4, the area of the heating surface 340 is less than the area of the liquid absorption surface 330.

In the example of FIG. 4, the heating surface 340 has smaller area than the liquid absorption surface 330 because the diameter of the heating surface 340 is less than the diameter of the liquid absorption surface 330.

In the example of FIG. 4, the porous body 320 is shaped as a truncated cone. With the porous body 320 having a truncated cone shape, the lateral face 350 has a curved shape, and the liquid absorption surface 330 and the heating surface 340 both have a circle shape. In another example, the liquid absorption surface 330 and the heating surface 340 may have an oval shape.

The porous body 320 tapers from the liquid absorption surface 330 towards the heating surface 340. In other words, the cross-sectional area of the porous body 320 gradually becomes smaller from the liquid absorption surface 330 towards the heating surface 340. In the example of FIG. 4, both the diameter of the porous body 320 decreases from the liquid absorption surface 330 towards the heating surface 340, which causes the tapering.

FIGS. 5 and 6 show a schematic illustration of a fourth example of a heater assembly 400 for an aerosol-generating system. The heater assembly includes a heating element 410 and a porous body 420.

The heating element 410 is configured to vaporise an aerosol-forming substrate, such as a liquid aerosol-forming substrate, to form an aerosol. The heating element 410 is configured to convert electrical energy into heat energy by material resistance of the heating element 410 to an electrical current.

The porous body 420 is configured to convey the liquid aerosol-forming substrate to the heating element 410. In other words, the porous body 420 supplies the liquid aerosol-forming substrate to the heating element 410.

The porous body 420 has a first end face and an opposing second end face. The first end face is a liquid absorption surface 430 and the second end face is a heating surface 440. In this example, the liquid absorption surface 430 and the heating surface 440 are both substantially flat surfaces. The porous body 420 also has a plurality of lateral faces extending between the liquid absorption surface 430 and the heating surface 440.

In this example, as will be discussed in more detail below, the porous body 420 has a first lateral face 450 opposing a second lateral face 460, and a third lateral face 470 opposing a fourth lateral face 480.

The porous body 420 comprises a plurality of pores. The plurality of pores are interconnected to provide a fluid pathway for liquid aerosol-forming substrate through the porous body 420, from the liquid absorption surface 430 to the heating surface 440. The porous body 120 is formed from a material that does not chemically interact with the liquid aerosol-forming substrate. In this example, the porous body 420 is a porous ceramic body and may be formed from, for example, Ca₂SiO₃ or SiO₂ (or Ca₂SiO₃ and SiO₂). In another example, the porous body 420 may be, for example, a porous glass body.

The heating element 410 is located on the heating surface 440 of the porous body 420. In the example of FIGS. 5 and 6, the heating element 410 is a porous film that extends across substantially all of the heating surface 440.

The liquid absorption surface 430 of the porous body 420 has an area that is different to an area of the heating surface 440 of the porous body 420. Specifically, in the example of FIGS. 5 and 6, the area of the liquid absorption surface 430 is less than the area of the heating surface 440.

In the example of FIGS. 5 and 6, the heating surface 440 has larger area than the liquid absorption surface 430 because the length of the heating surface 440 is greater than the length of the liquid absorption surface 430. In addition, or alternatively, in another example, the heating surface 440 may have a greater area than the liquid absorption surface 430 because the width of the heating surface 440 is greater than the width of the liquid absorption surface 430.

In the example of FIGS. 5 and 6, the porous body 420 is shaped as a trapezoid prism. With the porous body 420 having a trapezoid prism shape, the first lateral face 450 and the second lateral face 460 both have a trapezium shape, specifically an isosceles trapezoid, the third lateral face 470 and the fourth lateral face 480 both have a rectangle shape, and the liquid absorption surface 430 and the heating surface 440 both have a rectangle shape. In another example, the liquid absorption surface 430 and the heating surface 440 may have a square shape.

The porous body 420 tapers from the heating surface 440 towards the liquid absorption surface 430. In other words, the cross-sectional area of the porous body 420 gradually becomes larger from the liquid absorption surface 430 towards the heating surface 440. In the example of FIGS. 5 and 6, the length of the porous body 420 increases from the liquid absorption surface 430 towards the heating surface 440 which causes the tapering.

FIG. 7 shows a schematic illustration of a fourth example of a heater assembly 500 for use in an aerosol-generating system. The heater assembly 500 comprises a heating element 510 for vaporising a liquid aerosol-forming substrate. The heater assembly 500 also comprises a porous ceramic body 520 for conveying the liquid aerosol-forming substrate to the heating element 510. The porous ceramic body 520 has a liquid absorption surface 530 and an opposed heating surface 540 The heating element 510 is located on the heating surface 540 of the porous ceramic body 520.

The heating surface 540 of the porous ceramic body 520 is curved. In particular, the heating surface 540 of the porous ceramic body 520 is convexly curved in a single transverse direction.

The porous body 520 is prismatic in shape. When viewing a longitudinal cross-section perpendicular to the direction of curvature of the porous body 520, the heating surface 540 of the porous body 520 is shown as arc. The porous body 520 has two longitudinal planes of symmetry.

The heating surface 540 of the porous ceramic body 520 has a width 541 substantially the same as the width of the porous ceramic body 520, and substantially the same as the width of the heater assembly 500. The heating surface 5400f the porous ceramic body 520 has a width of about 5 millimetres.

The heating surface 540 of the porous ceramic body 520 has a length or thickness 542 of about 1 millimetre. The porous ceramic body 520 has a length or thickness 543 of about 3 millimetres.

The heating surface 520 of the porous ceramic body has a radius of curvature of about 3.6 millimetres. The heating surface 520 of the porous ceramic body has a surface area of about 28 square millimetres.

The porous body 520 comprises four longitudinal surfaces or side walls extending from the liquid absorption surface 530 to the heating surface 540. The four side walls are substantially perpendicular to the liquid absorption surface 530, which is substantially flat. The liquid absorption surface 530 is square in shape.

The heating element 510 is a resistive heating element.

The heating element 510 is curved. In particular, the curvature of the heating element is substantially the same as the curvature of the heating surface 540 of the porous ceramic body 520. As such, the heating element 510 is also convexly curved in a single transverse direction.

The heating element 510 is located directly on the heating surface 540 of the porous ceramic body 520. The heating element 510 extends across a majority of the heating surface 540 of the porous ceramic body 520. Substantially the entirety of the heating element 510 is in contact with the heating surface 540 of the porous ceramic body 520.

FIG. 8 shows a schematic illustration of a fifth example of a heater assembly 600 for an aerosol-generating system. The heater assembly includes a heating element 610 and a porous body 620.

The heating element 610 is configured to vaporise an aerosol-forming substrate, such as a liquid aerosol-forming substrate, to form an aerosol. The heating element 610 is configured to convert electrical energy into heat energy by material resistance of the heating element 610 to an electrical current.

The porous body 620 is configured to convey the liquid aerosol-forming substrate to the heating element 610. In other words, the porous body 620 supplies the liquid aerosol-forming substrate to the heating element 610.

The porous body 620 has a first end face and an opposing second end face. The first end face is a liquid absorption surface 630 and the second end face is a heating surface 640. In this example, the liquid absorption surface 630 and the heating surface 640 are both substantially flat surfaces. The porous body 620 also has a plurality of lateral faces extending between the liquid absorption surface 630 and the heating surface 640.

In this example, as will be discussed in more detail below, the porous body 620 has a first lateral face 650 opposing a second lateral face 660, and a third lateral face 670 opposing a fourth lateral face 680.

The porous body 620 comprises a plurality of pores. The plurality of pores are interconnected to provide a fluid pathway for liquid aerosol-forming substrate through the porous body 620, from the liquid absorption surface 630 to the heating surface 640. The porous body 620 is formed from a material that does not chemically interact with the liquid aerosol-forming substrate. In this example, the porous body 620 is a porous ceramic body and may be formed from, for example, Ca₂SiO₃ or SiO₂ (or Ca₂SiO₃ and SiO₂). In another example, the porous body 620 may be, for example, a porous glass body.

The heating element 610 is located on the heating surface 640 of the porous body 620. In the example of FIG. 8, the heating element 610 is an elongate porous film that extends in a meandering pattern across the heating surface 640.

The liquid absorption surface 630 of the porous body 620 has an area that is different to an area of the heating surface 640 of the porous body 620. Specifically, in the example of FIG. 8, the area of the heating surface 640 is less than the area of the liquid absorption surface 630.

In the example of FIG. 8, the heating surface 640 has smaller area than the liquid absorption surface 630 because the width of the heating surface 640 is less than the width of the liquid absorption surface 630, and because the length of the heating surface 640 is less than the length of the liquid absorption surface 630.

In the example of FIG. 8, the porous body 620 is shaped as a truncated pyramid. With the porous body 620 having a truncated pyramid shape, the first lateral face 650 and the second lateral face 660 both have a trapezium shape, the third lateral face 670 and the fourth lateral face 680 both have a trapezium shape, and the liquid absorption surface 630 and the heating surface 640 both have a rectangle shape. In another example, the liquid absorption surface 630 and the heating surface 640 may have a square shape.

The porous body 620 tapers from the liquid absorption surface 630 towards the heating surface 640. In other words, the cross-sectional area of the porous body 620 gradually becomes smaller from the liquid absorption surface 630 towards the heating surface 640. In the example of FIG. 8, both the length and the width of the porous body 620 decrease from the liquid absorption surface 630 towards the heating surface 640, which causes the tapering.

The heater assembly 600 includes a thermally insulating layer 690.

The heating element 610 is arranged along an outer surface of the thermally insulating layer 690. The heating element 610 is in direct contact with the thermally insulating layer 690.

The thermally insulating layer 690 is arranged to enhance thermal insulation between the heating element 610 and the porous ceramic body 620. The thermally insulating layer 690 is arranged to extend across at least a portion of the heating element 610 to thermally insulate the heating element 610 from the porous ceramic body 620. The thermally insulating layer 690 is configured to reduce heat dissipation through the porous ceramic body 620, so as to enhance energy efficiency by reducing energy losses.

The thermally insulating layer 690 is planar. The thermally insulating layer 690 has a size and a shape configured to extend across the electrical heating element 690. The thermally insulating layer 690 is configured to entirely extend across a surface of the heating element 610. The thermally insulating layer 690 is configured to substantially cover the porous ceramic body 620 below the thermally insulating layer 690.

The thermally insulating layer 690 has a first end face and an opposing second end face. The first end face is a liquid absorption surface and the second end face is a heating surface. In this example, the liquid absorption surface and the heating surface are both substantially flat surfaces. The liquid absorption surface of the thermally insulating layer 690 is in direct contact with the porous ceramic body 620. The heating surface of the thermally insulating layer 690 is in direct contact with the heating element 610, The thermally insulating layer 690 has a thickness defined between its liquid absorption surface and its heating surface. The thickness of the thermally insulating layer 690 is less than the thickness of the porous ceramic body 620. The thermally insulating layer may have a thickness between 0.1 mm and 2 mm, preferably between 0.5 mm and 1.5 mm.

The thermally insulating layer 690 comprises a material having a low thermal conductivity. The thermally insulating layer 690 comprises or consists of a material with a lower thermal conductivity than the porous ceramic body 620. The thermally insulating layer 690 may have a higher porosity than the porous ceramic body 620. The thermally insulating layer 690 may comprise a material such as one or more of: alumina, zirconia, zirconia with magnesium oxide, glass ceramic, quartz, a porous polymer. It will be appreciated that the thermally insulating layer 690 may have a different shape or comprise a different material.

Referring to FIGS. 9 (a), 9 (b) and 9(c), there are shown schematic illustrations of examples of different heating elements for an aerosol-generating system. Each heating element 710 comprises a plurality of tracks or track portions 717 arranged electrically in parallel. By being arranged electrically in parallel, current flow is split into separate parallel flow paths. The flow paths are subsequently re-combined.

In the heating elements of FIGS. 9 (a) to 9 (c), each heating element 710 comprises a first connecting pad 713 and a second connecting pad 714. The first and second connecting pads 713, 714 are configured to allow connection to an external circuit. An aperture or plurality of apertures 715 in the heating element 710 separate each track 717. Each heating element 710 comprises a diverging portion, in which current is split from the first connecting pad 713 into tracks 717 which define electrically parallel paths. Each heating element 710 comprises a converging portion, in which current is combined from tracks 717 which define electrically parallel paths, into the second connecting pad 714.

Various different arrangements are possible of tracks or track portions arranged electrically in parallel. In FIG. 9 (a), four tracks 717 are separated by three apertures 715 to define four electrically parallel paths. In FIG. 9 (b), six track portions 717 are separated by one aperture 715 to define two electrically parallel paths. In FIG. 9 (b), each electrically parallel path defines a serpentine path between the first connecting pad 713 and the second connecting pad 714. In FIG. 9 (c), eight track portions 717 are separated by four apertures 715 to define four pairs of electrically parallel paths. Each pair of electrically parallel path in FIG. 9 (c) is separated by an intermediate connection 716, of which three are shown in FIG. 9 (c).

By having tracks or track portions arranged electrically in parallel, if one track portion is defective, current can be redistributed and can still flow through the heating element 710, i.e. the electrical connection between the first connecting pad 713 and the second connecting pad 714 is not broken. This has the advantage of increasing the number of puffs before full failure of the heater, and potentially increasing the heater lifetime up to the lifetime of the device. In contrast, in a simple serpentine heater defining a single electrical path between a first connecting pad 713 and a second connecting pad 714, if a part of the serpentine heating element is broken, then the heating element will stop working due to an increase in local resistance at the breakage or defect point. A defect in a simple serpentine heater causes an increase in local resistance. An increase in local resistance causes increased power dissipation. Increased power dissipation in turn increases the resistance until breakage.

The inventors have also identified that the parallel tracks or track portions arranged electrically in parallel, explained with reference to FIGS. 9 (a) to (c), has a surprising additional advantage. In such an arrangement, in case of breakage of one track portion, the heating element 710 will still operate and can, for an initial transitory period, operate in an advantageous way, because the breakage of one track or track portion would result in a higher energy density on the remaining tracks or track portions. In such a case, the same power would still be provided but on a smaller area, so the throughput would be increased. While such a breakage causing an increase in current on unbroken tracks or track portions can eventually degrade the user experience, the device or cartridge can include a mechanism to alert the user about possible future below optimal performance of the heater assembly.

Such a mechanism relies on the following principles. The total electrical resistance of the heating element depends on the following factors:
1) the number of heating tracks in parallel (more parallel tracks decrease the total resistance);
2) the cross-sectional area (width or thickness (or width and thickness)) of the parallel heating tracks (a higher cross-sectional area leads to a lower resistance);
3) the length of the parallel heating tracks (longer tracks have a higher resistance);
4) if the heating element is porous, tuning the porosity of heating element (higher porosity increases resistance);
5) particular chemical or material composition (e.g. alloys by doping).

The overall total heating element resistance Rₜₒₜ of an arrangement of a number of heating tracks or track portions (i) arranged in parallel such that electric current in at least two neighbouring tracks or track portions flows in the same direction, Ri is set out in equation 1:

$$\frac{1}{{R}_{tot}} = {\sum }_{i}^{n} \frac{1}{{R}_{i}} \qquad ( 1 )$$

where n is the total number of heating tracks arranged electrically in parallel.

The behavior of a parallel track heating element 710 when one heating track fails can be considered with reference to a heating element 710 with 4 parallel heating tracks, for example as shown in FIG. 9 (a). The heating tracks each have a resistance of 3 Ohms. The total resistance of the heating element is 0.75 Ohms, calculated using equation 1.

When one heating track starts to fail, the resistance of the failing heating track increases. The total resistance of the heating element 710 also starts to increase, following a linear relationship with the failing heating track resistance. However, as the heating track resistance continues to increase, the heating element 710 resistance asymptotes to a constant resistance value. At this constant resistance value, the influence of the failing heating track on the heating element resistance is capped. In this example where unbroken heating tracks each have a resistance of 3 Ohms, the total resistance of the heating element that asymptotes to 1 Ohm when the failed track can be considered as an open circuit (i.e. no more current can flow through it). When one track breaks in this example, only three tracks remain for the purpose of calculating the total heating element resistance.

To consider the behavior of such a heating element 710, a supply voltage of 3.5 Volts and target power of 5.5 Watts are considered. In this example, unbroken parallel heating tracks remain with their initial resistance of 3 Ohms. In the failing track, the total maximum current decreases with increasing resistance. In the failing track, current decreases to zero once broken. The current through the unbroken parallel tracks remains substantially constant as the resistance of the failing track increases (if resistance change due to temperature increase is ignored).

A similar behavior is observed for the maximum heating power generation. Less total power is generated once a heating track has failed. However, in this example, the maximum power remains higher than the target of 5.5 Watts despite failure of one of the heating tracks.

In contrast to a porous heater film, the overall heating element resistance increase of the parallel track heating element 710 can be monitored by control electronics. In a heater film, a damaged area may widen with time until failure occurs, because the current density across the heater film (perpendicular to the current flow) increases at the damaged area, generating more power, elevating the local temperature. This locally increases the resistance of the heater film, further increasing the temperature until breakdown (i.e., positive feedback). In the parallel track heating element 710, in contrast, the overall heating element resistance increase can be monitored by the control electronics. The device or system may be configured such that when a predetermined threshold is reached, the device or system tells the user through a user interface that the heater assembly should be exchanged.

The aerosol-generating device or system may comprise control circuitry. The control circuitry may be configured to, after detecting the failure of a heating track for example by a feedback loop, adjust the power fed to the heater. The control circuitry may be configured to provide a pulse width modulation (“PWM”) signal to control the power fed to the heater. The control circuitry may adjust the power fed to the heater by adjusting the duty cycle of the pulse width modulation signal. In an example, control circuitry may be configured to have a duty cycle at 33.7 percent when the heating tracks are in a normal condition. The duty cycle may increase to 44.9 percent when one of the heating tracks has failed. When one of the heating tracks fails, the power density (heating power generated by surface area) increases, enhancing the thermal efficiency of the heater body. Therefore, the proper operation of the heater is not jeopardized with one failed heating track. A similar result occurs if a second heating track breaks. The control circuitry may be configured such that the duty cycle further increases (to 67.4 percent in the current example). Thus, a heating element 710 with four parallel heating tracks can still operate with the nominal condition of 5.5 Watts even if two of these heating tracks are broken, since the duty cycle remains below 100 percent.

The control circuitry may be configured such that, based on the change of nominal total resistance of the heating element 710 once a parallel heating track has failed, it is possible for the control circuitry to assess the state of the heating element (i.e., number of heating tracks which have failed). The control circuitry may be configured such that, after a predefined number of heating track(s) have failed, the device can tell the user that the heater assembly should be changed.

Referring to FIGS. 10 (a) and 10 (b), there are shown schematic illustrations of current flow 709 around a corner of a heating element track.

FIG. 10 (a) is a schematic illustration of current flow 709 around a known heating element in which a track portion defines a path having a bend, the inner edge of the bend having a sharp corner. In such a track, current flow depicted by arrows 709, which follows a path of least resistance, is concentrated (i.e., there is an increase in current density). This concentration occurs at an inner edge of the corner. Current concentration can increases the local temperature, and can lead to the presence of hot spot at the corner. A hot spot is disadvantageous, as it can affect the efficiency and reliability of the heating element. A hot spot occurs despite the potential for local resistivity of the heater track material to increase due to a local increase in temperature (which would direct current flow away to a path of lower resistance).

FIG. 10 (b) is a schematic illustration of current flow 709 around a heating element 710 in which a track portion 717 defines a path having a bend, the inner edge of the bend being curved. In such a track 717, current flow 709 does not form a local hot spot.

In contrast to the track shape shown in FIG. 10 (a), current flow 709 in the smoother curved track portion 717 as shown in FIG. 10 (b) remains more evenly distributed across the heating track 717, as depicted by dashed arrows 709. Current flow 709 is guided to flow more evenly, to avoid a concentration of current at any point. This in turn limits hot spot creation. The heater track 717 may have a gradient of electrical resistivity perpendicular to current flow in a corner or corners, such that the electrical resistivity is higher at an inner part of the corner and lower at an outer part of the corner. Such a gradient is beneficial to counterbalance localized high current density and reduce hot spot creation.

FIG. 11 is a schematic illustration of the interior of an aerosol-generating system 800 according to an example of the present disclosure. The aerosol-generating system 800 comprises two main components, a cartridge 801 and a main body part or aerosol-generating device 900. The cartridge 801 is removably connected to the aerosol-generating device 900. The aerosol-generating device 900 comprises a device housing 901 that contains a power supply in the form of a battery 902, which in this example is a rechargeable lithium ion battery, and control circuitry 903. The aerosol-generating system 800 is portable and has a size comparable to a conventional cigar or cigarette. A mouthpiece is arranged at a mouth end of the cartridge 801.

The cartridge 801 comprises a cartridge housing 802 containing a heater assembly 100 and a liquid reservoir or liquid storage portion 803 for holding a liquid aerosol-forming substrate. Liquid aerosol-forming substrate is conveyed downwards from the liquid absorption surface 130 through the porous body to the heating element and vaporised aerosol-forming substrate is emitted from the heating surface 140 when electrical power is supplied to the heating element.

The cartridge 801 comprises one or more air inlets 804 formed in the cartridge housing 805 at a location along the length of the cartridge 801. An aerosol outlet 806 is located in the mouthpiece at the mouth end of the cartridge 801. The one or more air inlets 804 are in fluid communication with the aerosol outlet 806 to define an airflow pathway through the cartridge 801 of the aerosol-generating system 800. The airflow pathway flows from the one or more air inlets 804 to the heater assembly 100 in an airflow channel. The heater assembly 100 is arranged in fluid communication with the airflow pathway in the airflow channel. Air enters the one or more air inlets 804 and flows through the airflow channel past the heater assembly 100 in an average airflow direction.

In the example of FIG. 10, the liquid storage portion 803 is annular in cross-section and is arranged around a central sealed aerosol channel 807. Once the airflow pathway reaches the heater assembly 100, it is diverted upwards around the sides of the heater assembly 100 and flows through the aerosol channel 807 to the aerosol outlet 806.

The aerosol-generating system 800 is configured so that a user can puff or draw on the mouthpiece of the cartridge to draw aerosol into their mouth through the aerosol outlet 806. In operation, when a user puffs on the mouthpiece, air is drawn in through the one or more air inlets 804, along the airflow pathway through the airflow channel, past and around the heater assembly 100 and along the airflow pathway through the aerosol channel 807 to the aerosol outlet 806. The control circuitry 903 controls the supply of electrical power from the battery 902 to the cartridge 801 when the system is activated. This in turn controls the amount and properties of the vapour produced by the heater assembly 100. The control circuitry 903 includes an airflow sensor (not shown) and supplies electrical power to the heater assembly 100 when user puffs are detected by the airflow sensor. This type of control arrangement is well established in aerosol-generating systems such as inhalers and e-cigarettes. When a user puffs on the mouthpiece of the cartridge 801, the heater assembly 100 is activated and generates a vapour that is entrained in the airflow pathway. The vapour cools within the airflow pathway to form an aerosol, which is then drawn into the user's mouth through the aerosol outlet 806

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ±10 percent (10%) of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. A heater assembly for an aerosol-generating system, the heater assembly comprising:
a heating element configured to vaporise a liquid aerosol-forming substrate; and
a porous body configured to convey the liquid aerosol-forming substrate to the heating element, the porous body having a liquid absorption surface and a heating surface,
the heating element being located on the heating surface of the porous body,
wherein the liquid absorption surface of the porous body has an area that is different from an area of the heating surface of the porous body,
wherein the porous body comprises a shape that tapers from the liquid absorption surface of the porous body towards the heating surface of the porous body, and
wherein the porous body further comprises a porous ceramic body or a porous glass body.

17. The heater assembly according to claim 16, wherein the area of the heating surface of the porous body is less than the area of the liquid absorption surface of the porous body.

18. The heater assembly according to claim 16, wherein a ratio of the area of the heating surface of the porous body to the area of the liquid absorption surface of the porous body is less than or equal to 0.9.

19. The heater assembly according to claim 16, wherein a ratio of the area of the heating surface of the porous body to the area of the liquid absorption surface of the porous body is at least 0.1.

20. The heater assembly according to claim 16, wherein a ratio of the area of the heating surface of the porous body to the area of the liquid absorption surface of the porous body is between 0.1 and 0.9.

21. The heater assembly according to claim 16, wherein the heating surface of the porous body has a width that is less than a width of the liquid absorption surface of the porous body.

22. The heater assembly according to claim 16, wherein the area of the liquid absorption surface of the porous body is less than the area of the heating surface of the porous body.

23. The heater assembly according to claim 22, wherein the liquid absorption surface of the porous body has a width that is less than a width of the heating surface of the porous body.

24. The heater assembly according to claim 22, wherein the porous body comprises a shape that tapers from the heating surface of the porous body towards the liquid absorption surface of the porous body.

25. The heater assembly according to claim 16, wherein the heating surface of the porous body is convex in one or both of a first transverse direction and a second transverse direction, the first transverse direction being orthogonal to the second transverse direction.

26. The heater assembly according to claim 16, wherein an average pore size of the porous body varies between the liquid absorption surface and the heating surface.

27. The heater assembly according to claim 26,
wherein the porous body has a heating end and a liquid absorption end, the heating surface being disposed at the heating end, and the liquid absorption surface being disposed at the liquid absorption end, and
wherein the porous body has a first average pore size at the liquid absorption end, and a second average pore size at the heating end, the first average pore size being greater than the second average pore size.

28. A cartridge for an aerosol-generating system, the cartridge comprising:
the heater assembly according to claim 16; and
a liquid storage portion configured to hold a liquid aerosol-forming substrate, wherein the liquid storage portion is arranged at the liquid absorption surface of the porous body.

29. An aerosol-generating system, comprising:
the cartridge according to claim 28; and
an aerosol-generating device comprising:
a power supply configured to supply electrical power to the heating element, and
control circuitry configured to control a supply of power from the power supply to the heating element.
